(19) United States
(12) Patent Application Publication
(10) Pub. No.: US 2023/0274177 A1
(43) Pub. Date: Aug. 31, 2023

(54) METHOD FOR GENERATION OF RANDOM QUANTUM STATES AND VERIFICATION OF QUANTUM DEVICES

(71) Applicant: California Institute of Technology, Pasadena, CA (US)

(72) Inventors: Manuel Endres, Pasadena, CA (US); Adam L. Shaw, Pasadena, CA (US); Soonwon Choi, El Cerrito, CA (US); Daniel K. Mark, Cambridge, MA (US); Joonhee Choi, Pasadena, CA (US)

(73) Assignees: California Institute of Technology, Pasadena, CA (US); Massachusetts Institute of Technology, Cambridge, MA (US); The Regents of the University of California, Oakland, CA (US)

(21) Appl. No.: 18/175,378

(22) Filed: Feb. 27, 2023

Related U.S. Application Data
(60) Provisional application No. 63/345,363, filed on May 24, 2022.
(60) Provisional application No. 63/314,266, filed on Feb. 25, 2022.

(51) Int. Cl. G06N 10/70; G06N 10/20; G06N 10/40

(52) U.S. Cl. CPC G06N 10/70; G06N 10/20; G06N 10/40

(57) ABSTRACT

Systems and methods for generating random quantum states or benchmarking quantum machines.

### BACKGROUND OF THE INVENTION

### 1. Field of the Invention

The present invention relates to methods and systems for random state generation and quantum device verification.

### 2. Description of the Related Art

Generation of random ensembles of quantum states or processes has important applications in quantum information science associated with quantum supremacy tests, quantum cryptography, and quantum device verification. However, in existing methods, generating random quantum states requires highly engineered, time-dependent control of quantum hardware. In particular, this requirement limits the application of existing device verification protocols based on such random ensembles to a narrow class of quantum systems. Moreover, such protocols are limited to deep quantum evolution. What is needed are improved devices for generating random quantum states and benchmarking quantum devices. The present disclosure satisfies this need.

### SUMMARY OF THE INVENTION

Example methods, devices and systems according to embodiments described herein include, but are not limited to, the following:

1. A system for generating a pseudo random quantum state, comprising:
a quantum device comprising a plurality of coherently interacting quantum systems having a plurality of quantum degrees of freedom (e.g., position and/or atomic levels or states), wherein the quantum systems are prepared with a (e.g., high, that does not change based on system size, that is greater than 0.00001, and/or that is better than can be classical simulation) fidelity in a well characterized (e.g., pure) quantum state for the multiple quantum degrees of freedom;
a signal source (e.g., laser) for applying one or more signals that quantum mechanically evolve the quantum state under the influence of couplings (e.g., intensity of a laser field driving transitions between quantum states to evolve the quantum state) and interactions (e.g., van der Waals interactions) between the quantum systems and/or between the quantum systems and a source of decoherence; and
a detection system for performing a measurement on a subset of the quantum systems resulting in a second quantum state of the unmeasured quantum systems, wherein the second quantum state is used as a source of pseudo random quantum states.

2. The device of example 1, wherein:
the quantum systems comprise neutral atoms, quantum dots, solid state defects, superconducting qubits or audits, or trapped ions;
the subset comprises a first plurality of the quantum systems; and
the unmeasured quantum systems comprise the remaining number of the quantum systems.

3. The system of example 1, wherein:
the quantum device comprises an array of neutral atoms trapped in trapping potentials;
the quantum ems each comprise one of the atoms comprising a first state and a second state;
the signals comprise coherent electromagnetic radiation configured to:
   initialize the systems in the first state, and
   quantum mechanically evolve the systems by applying the coherent electromagnetic radiation continuously driving a transition between the first state and second state, under the influence of the coherent electromagnetic radiation driving the transition and the interactions between the atoms;
the interactions comprise van der Waals interactions between the atoms; and the degrees of freedom comprise the first state and the second state.

4. A computer implemented method to verify a quantum device, comprising:
obtaining a quantum device comprising one or more quantum systems each having a quantum state for multiple quantum degrees of freedom; and
verifying at least one of a coupling strength between the quantum systems and/or between a source of decoherence and the quantum systems, or
a fidelity of the quantum state; and
wherein the verifying comprises comparing measurement samples of an evolved quantum state of the quantum systems, against expected behavior with time evolution obtained using a classical computer, to estimate at least one of the fidelity or the coupling strength.

5. The method of example 4, wherein the comparing is performed using an equation for the fidelity.

6. The method of example 5, wherein the equation is:

$${F}_{c} = 2 \frac{{\sum }_{𝓏} p ( 𝓏 ) q ( 𝓏 )}{{\sum }_{𝓏} {p}^{2} ( 𝓏 )} - 1 or$$

$${F}_{d} = 2 \frac{{\sum }_{𝓏} p ( 𝓏 ) q ( 𝓏 ) / {p}_{d} ( 𝓏 )}{{\sum }_{𝓏} {p}^{2} ( 𝓏 ) / {p}_{d} ( 𝓏 )} - 1 or$$

$${F}_{e} = \frac{- 1 + {\sum }_{𝓏} p ( 𝓏 ) q ( 𝓏 ) / {p}_{d} ( 𝓏 )}{- 1 + {\sum }_{𝓏} {p}^{2} ( 𝓏 ) / {p}_{d} ( 𝓏 )}$$

where p(z) is the probability of the degree of freedom z from a calculation, q(z) is the probability from the measurement samples, and p_{d}(z) is the time-averaged probability from the calculation.

7. The method of example 5, wherein:
the equation for the fidelity is a function of one or more parameters characterizing the coupling strength that are measured in the measurement sample, and
the coupling strength is estimated using a variational method wherein the fidelity calculated from the equation is maximized by varying the one or more parameters in the equation.

8. The method of example 5, wherein the equation for the fidelity is a function of the measurement samples and the estimate is obtained by calculating the fidelity from the equation.

9. The method of example 4, wherein the time evolution obtained using the classical computer uses one or more classical approximate time evolution algorithms while utilizing an approximation method to estimate the fidelity of the quantum state via an extrapolation method.

10. The method of example 9, wherein the approximate time evolution algorithms comprise one or more tensor network based algorithms, one or more path integral sampling algorithms, and/or one or more machine learning based algorithms.

11. The method of example 9, wherein a performance of the approximate time evolution algorithm is systematically tuned in order to perform the extrapolation method.

12. The method of example 11, wherein the performance of the approximate time evolution algorithm comprising a tensor based network algorithm can be tuned by changing a bond dimension.

13. The method of example 11, wherein the systematic tuning is at least one of short delay time extrapolation or extrapolation via classical control.

14. The method of example 4, wherein the verifying characterizes the coupling strength by:
(a) preparing the quantum state of the quantum device, wherein the quantum state is well known (e.g., a pure quantum state) and/or preparing the quantum state with a fidelity that does not change based on system size, that is greater than 0.00001, and/or that is better than can be classical simulation);
(b) applying one or more signals to quantum mechanically evolve the well known quantum state under an influence of couplings (e.g., intensity of laser field driving transitions between atomic levels) and/or interactions (e.g., but not limited to, van der Waals interactions) between the quantum systems and/or between the quantum systems and a source of noise;
(c) performing a measurement on all quantum degrees of freedom (e.g., position and/or atomic levels) of the quantum systems resulting in a particular measurement sample of the quantum state;
(d) repeating steps (a)-(c) to obtain a plurality of the measurement samples (e.g. measurements); and
(e) comparing the measurement samples against the expected behavior with the time evolution obtained using the classical computer to obtain the estimate of the coupling strength.

15. The method of example 4, wherein the verifying characterizes the fidelity by:
(a) preparing the quantum state with unknown fidelity;
(b) applying one or more signals to quantum mechanically evolve the quantum state for a well known time duration under an influence of known couplings (e.g., intensity of laser field driving transition between atomic levels) and interactions (e.g., van der Waals interactions), to form an evolved quantum state;
(c) performing measurement on all quantum degrees of freedom of the evolved quantum state resulting in a particular measurement sample of the evolved quantum state;
(d) repeating steps (a)-(c) to obtain a plurality of the measurement samples (e.g., measurements); and
(e) comparing the measurement samples against the expected behavior with time evolution obtained using the classical computer to obtain the estimate of the fidelity of the quantum state.

16. The method of example 4 wherein the verifying characterizes the fidelity and the coupling strength simultaneously by:
(a) preparing an initial quantum state of the quantum device, wherein the initial quantum state is initially imperfectly known with unknown fidelity;
(b) applying one or more signals to quantum mechanically evolve the quantum state for a known time duration and under an influence of couplings and interactions between the quantum systems and/or between the quantum systems and a source of noise, wherein the couplings are initially imperfectly unknown;
(c) performing a measurement on all quantum degrees of freedom of the quantum systems resulting in a particular measurement sample of the quantum state;
(d) repeating steps (a)-(c) to obtain a plurality of the measurement samples; and
(e) comparing the measurement samples against the expected behavior with the time evolution obtained using the classical computer to obtain the estimate of the coupling strength and/or the estimate of the fidelity, wherein:
the estimate of the fidelity in step (e) is used as an input to provide knowledge of the fidelity in a next iteration of step (a), and
the estimate of the coupling strength obtained in step (e) is an input to provide the knowledge of the coupling in step (b), so that performance of the method simultaneously estimates the fidelity of the initial quantum state and the coupling strength.

17. The method of example 4, wherein:
the quantum device comprises an array of neutral atoms trapped in trapping potentials and the quantum systems comprise a first state and a second state of each of the atoms, and
the interactions comprise interactions between the atoms, and
the couplings comprise coherent electromagnetic radiation driving a transition between the first state and the second state and the coupling strength is a function of the detuning of the coherent electromagnetic radiation from the transition.

18. A computer implemented system for verifying a quantum device, comprising:
a computer coupled to or more quantum systems each having a quantum state for multiple quantum degrees of freedom, wherein:
the computer comprises one or more processors; one or more memories; and an application stored in the one or more memories, and
the application executed by the one or more processors verifies at least one of:
   a coupling strength between the quantum systems and/or between a source of decoherence and the quantum systems, or
   a fidelity of the quantum state of interest,
   by comparing measurement samples of an evolved quantum state of the quantum systems, against expected behavior with time evolution determined by the computer, to estimate at least one of the fidelity or the coupling strength.

19. The computer implemented system of example 18, wherein the application
estimates the fidelity or the coupling strength by solving an equation for the fidelity:

20. The system of example 18, wherein the computer outputs an error detection signal if at least one of the fidelity or the coupling strength are outside an acceptable range of the expected behavior.

21. The system of example 18, wherein the quantum device comprises a quantum simulator or quantum computer.

22. A method to verify the fidelity of preparing a specified target quantum state.

23. A scheme for maximum likelihood estimation of experimental parameters via parametrized quantum states.

24. A process to directly compare the evolution fidelity of digital and analog quantum devices.

25. Systems and methods verify accuracy of quantum machines using their randomness.

26. In various examples, “couplings” refers to single-particle control by an external control field, and “interactions” refers to multi-particle control mediated by their mutual interaction.

### BRIEF DESCRIPTION OF THE DRAWINGS

Referring now to the drawings in which like reference numbers represent corresponding parts throughout:

FIGS. 1A-1E|Random pure state ensembles from Hamiltonian dynamics. 1A, a programmable device producing arbitrary quantum states |ψⱼ [symbol] through unitary operations Uⱼ, where j enumerates over different program setting. 1B, Repeatedly applying explicitly randomized unitary evolution to an initial state |Ψ₀ [symbol] produces an ensemble of pure quantum states |ψⱼ [symbol] (blue arrows) which is distributed near-uniformly over the Hilbert space, [symbol] (grey sphere), a random state ensemble. 1C, Creating random state ensembles based on only a single instance of time-independent Hamiltonian evolution. An initial product state evolves under a Hamiltonian, Ĥ, before site-resolved projective measurement in the computational basis {|0 [symbol] , |1 [symbol] }. The system is bi partitioned into two subsystems A and B of length L_{A} and L_{B}, respectively, and the conditional measurement outcomes analyzed in subsystem A, z_{A}, given a specific result z_{B} from the complement B. These outcomes are described by the projected ensemble, a pure state ensemble in A, {|ψ_{A}(z_{B}) [symbol] }, realized through measurement of B. 1D, As an example, when L_{A}=1, conditional single-qubit quantum states |ψ_{A}(z_{B}) [symbol] are visualized on a Bloch sphere for all possible z_{B} bitstrings. 1E, Numerical simulations of the experimental system show that the distribution of the conditional pure state ensemble in A changes during evolution into a near-random form, with selected states highlighted to demonstrate their late-time divergence despite similar initial conditions.

FIG. 1F. Example Rydberg Simulator implemented with Atoms.

FIGS. 1G-1I. Clouse up of experimental system and parameter feedback: 1G, Illustration of a Rydberg quantum simulator consisting of strontium-88 atoms trapped in optical tweezers (red funnels). All atoms are driven by a global transverse control field (purple horizontal beam) at a Rabi frequency Ω and a detuning Δ (right panel). The interaction strength is given as C₆/Rᵢⱼ⁶ with an interaction constant C₆ and atomic separations Rᵢⱼ between two atoms at site i and j. 1H, Schematic of the experimental feedback scheme. We automatically interleave data taking with feedback to global control parameters and systematic variables through a home-built control architecture; in particular, we feedback to the clock laser frequency (to maintain optimal state preparation fidelity), the Rydberg laser alignment, the Rydberg detuning Δ, and the Rabi frequency Ω. 1H, Example of the interleaved automatic Rabi frequency stabilization over the course of ≈20 hours with no human intervention. Feedback is comprised of performing single-atom Rabi oscillations, fitting the observed Rabi frequency, and updating the laser amplitude, rather than simply stabilizing the laser amplitude against a photodiode reference. FIG. 1I shows while the Rabi frequency setpoint (orange squares) changes over the course of the sequence (due to long-time instabilities like temperature drifts), the measured Rabi frequency (blue circles) stays constant to within <0.3%, with a standard deviation of 0.15%. This same stability is seen over the course of multiple days with nearly continuous experimental uptime.

FIGS. 2A-2E Experimental signatures of random pure state ensembles. 2A, 10-atom Rydberg quantum simulator to perform Hamiltonian evolution leading to quantum thermalization at infinite effective temperature. For a single qubit in A, the probabilities for finding a single qubit subsystem in state 0 as a function of time are plotted. Grey square marks indicate the marginal probabilities p(z_{A}=0), which equilibrate to ˜0.5 due to thermalization with B. In contrast, colored circle markers show conditional probabilities given a specific measured z_{B} in B, p(z_{A}=0|z_{B}), which show large fluctuations even after the marginal probability reaches a steady state; these then diminish at late times due to decoherence effects. Such conditional probabilities are signatures of the projected ensemble as p(z_{A}|z_{B})=| [symbol] z_{A}|ψ_{A}(z_{B}) [symbol] |². Grey lines are simulated trajectories of p(z_{A}=0|z_{B}) for all outcomes z_{B}, with a few highlighted to be compared with experimental data (color lines and markers). Decoherence sources⁴⁶ are included for simulations after the axis break. 2B, Histograms, P(p), of the probabilities p(z_{A}=0|z_{B}) at intermediate (Ωt₀/2π=2.3) time. The experimental results are close to a flat distribution, as expected from an ensemble of uniformly distributed single-qubit states on a Bloch sphere (right). 2C, However, at late (Ωt₁=2π=38) time, decoherence effects have reduced the purity of the states in A, concentrating probabilities around 1/D_{A}=0.5, (see main text). 2D, 2E, Similar agreement with predictions from random state ensembles is also seen for larger subsystem sizes of A with higher D_{A} values (Methods). In 2b-2e, black lines and grey bands are predictions and uncertainties of a D_{A}-dimensional uniform random ensemble; red dashed lines and blue solid lines are from simulations with and without decoherence⁴⁶, respectively.

FIGS. 3A-3C|Development of emergent randomness. 3A, Rescaled second (red), third (purple), and fourth (blue) moments of the conditional probability distributions in FIG. 2c for subsystem of length L_{A}=2. Experimental moments saturate to ≈k 12 at early times (Ωt/2π˜2), the expectation from the uniformly random ensemble (dotted lines) and consistent with numerical simulation (solid lines). 3B, Numerically computed trace distances as a function of time between the L_{A}=2 projected ensemble and the four lowest order approximations to the uniform random ensemble, so called quantum state k-designs, for k=1,2,3,4 (inset). Distances for all k decrease initially before saturating due to finite system-size effects⁴⁶. If the trace distances up to order k vanish, the ensemble is as random as the k^{th} design, and fluctuations of observables match up to order k, such as the k^{th} moments in a. 3C, Late-time distances decrease as ˜1/\sqrt{D_{B}} (solid lines), the Hilbert space dimension of the effective bath, subsystem B.

FIG. 4. Flowchart illustrating a method of characterizing coupling strength.

FIG. 5. Flowchart illustrating a method of characterizing fidelity.

FIG. 6. Flowchart illustrating a method of simultaneously characterizing fidelity and coupling strength.

FIGS. 7A-7D Fidelity estimation of an analog Rydberg quantum simulator. 7A, Schematic of noisy time evolution with an error occurring at time tₑᵣᵣ. The influence of the local error propagates outward, affecting the measurement outcomes non-locally at a later time. 7B, Errors during evolution can be detected by correlating the measurement outcomes with an error-free, ideal evolution case—here numerically tested by applying a local, instantaneous phase error to the middle qubit of an N=16 atom Rydberg simulator at time Ωtₑᵣᵣ/2π≈1. The proposed fidelity estimator, Fₑ (dashed line), accurately approximates the many-body overlap (solid line) between states produced with and without errors, after a slightly delayed time. Inset: Conditional probability distributions in A before (blue) and after (red) the error, showing decorrelation. 7C, To estimate experimental fidelity, we repeatedly perform Hamiltonian evolution, each time performing a projective measurement to accrue an ensemble of measured bitstrings zₑₓₚ. The measured bitstrings are then correlated with an error-free simulation of the dynamics in order to calculate the fidelity estimator, F_{e,exp}. To validate the fidelity estimation method, the error-free simulation is compared against results from an ab initio error model⁴⁶, to calculate the model fidelity F_{model} and accompanying estimator F_{e,model}. d, Experimental benchmarking of a Rydberg quantum simulator for N=10 and N=20 atoms. Shown are F_{e,exp} (grey markers), the fidelity F_{model} (dashed red line), and F_{e,model} (solid pink line)—all are in good agreement with each other. As a time-reference, we also plot the growth and saturation of the half-chain entropy (blue line).

FIGS. 8A-8D Hamiltonian learning and target state benchmarking. 8A, Normalized, time-integrated Fₑ, F̅ₑ, as a function of the global Rabi frequency, detuning, and the next-nearest-neighbor interaction strength in the Rydberg model; Fₑ is maximized only when the correct parameters are used. Vertical dashed lines and shaded areas denote independently calibrated values and their uncertainties. 8B, Programmed (grey bars) and learned (red bars) local Hamiltonian parameters for an arbitrary, site-dependent detuning field imposed with an intensity-dependent lightshift from locally addressable optical tweezers (inset, red funnels). 8c,d, Our protocol can estimate the fidelity of producing a specified target state by evolving at infinite effective temperature after preparation, here numerically demonstrated for a ground state of system size N=15 near the [symbol] ₂ Ising quantum phase transition in the one-dimensional Rydberg ground state phase diagram⁵⁰, with a “noisy” state consisting of an equal probability mixture of the ground and first excited states.

FIGS. 9A-9F. Schematic of benchmarking protocol. 9A Measurement snapshots {z₁, . . . , z_{M}} drawn from a distribution q(z), associated with an experimentally prepared state ρₑₓₚ, are compared against the theoretical probability distribution p(z) associated with an ideal pure state |Ψ_{ideal} [symbol] . 9B The raw distributions p(z) and q(z) (blue and red bars, left) exhibit a systematic pattern (dashed lines), giving rise to a non-universal histogram of probabilities. Via proper normalization, the systematic pattern is eliminated, leading to a processed distribution \tilde{p}(z) that only exhibits a speckle pattern, approximately following the universal Porter-Thomas distribution (right). F_{d} estimates the overlap fidelity F between ρₑₓₚ, and |Ψ_{ideal} [symbol] , by comparing the speckle patterns that serve as fingerprints of the quantum state. 9C F_{d} closely tracks the decay of fidelity F (black dashed) between noisy and ideal quench dynamics as a function of evolution time for a 1D Bose-Hubbard model. In contrast, other proposed benchmarks F_{XEB} (green dotted) or Fₑ (purple dot-dashed) show significant deviations due to the finite effective temperature of the initial state we consider [35]. (9d-f) Our method is applicable to a wide class of analog simulators including an integrable 1D Fermi-Hubbard model, a trapped-ion model, and a 2D Rydberg array.

FIGS. 10A-10D. Detailed analysis of our benchmarking protocol. 10A We simulate open quantum dynamics of a 1D Bose-Hubbard model with N particles on N sites based on the stochastic wavefunction method [52] and analyze individual quantum trajectories (green) corresponding to specific occurrences of errors. In each trajectory, F_{d} (solid line) closely agrees with the fidelity F (dashed line). It takes a short delay time for F_{d} to approach F (black arrow). Averaging F_{d} and F across all trajectories gives their overall values for the mixed state p (blue line). Inset: Even after our benchmark F_{d} may slightly deviate from F owing to a systematic difference δ_{sys} between F and the time-averaged F_{d} (red arrow) and the fluctuation δₜₑₘₚ of F_{d} over time (green arrow). When F_{d} is estimated from a finite number of samples M, the unbiased estimator \hat{F}_{d} [Table I] (orange marker) has a statistical uncertainty δₛₜₐₜ (error bar) (10b,c) Both δ_{sys} and δₜₑₘₚ decrease exponentially with system size, up to N=9 studied here (corresponding to a Hilbert space dimension of 24310), consistent with our analytic prediction (dashed lines). 10(d) The sample complexity Mδₛₜₐₜ² increases weakly with N at early times (dotted line). At late times, however, it approaches an N-independent, universal value (dashed line). Error bars in (10b-d) indicate the fluctuations over an ensemble of disordered Hamiltonians.

FIGS. 11A-11C. Estimating unknown parameters of a quantum state or Hamiltonian based on F_{d}: 11(a) the phase ϕ for a GHZ-like initial state in a 2D Rydberg system; 11(b) the normalized interaction strength, U/J, for a 1D Bose-Hubbard model where U and J are the interaction and tunneling strengths; and (c) ten disordered on-site potentials in a trapped ion model. The parameters are estimated by maximizing \hat{F}_{d} over simulated parameters, assuming error-free (blue, middle row) or noisy (red, bottom row) quench evolution. The error bars and shaded regions indicate the statistical uncertainty in \hat{F}_{d} and the estimated parameter values when 1000 samples are used. See SM for simulation details. (11a,b) Both F (black lines) and \hat{F}_{d} (marker) are consistent with each other and simultaneously maximized at the true parameter value (dotted line) 11(c) All ten disorder potential values are approximately reconstructed.

FIG. 12. Hardware environment for controlling quantum device and/or performing benchmarking classical computations.

FIG. 13. Example network environment for controlling quantum device and/or performing benchmarking computations.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

### Technical Description

Example methods, systems, and devices described herein utilize dynamically generated quantum correlations to generate random ensembles during generic chaotic quantum evolution as realized by a wide class of quantum systems, including analog quantum simulators. Other example methods, devices, and systems implement a novel device verification protocol based on the generation of random ensembles of quantum states. In contrast to existing protocols, the device verification protocol(s) described herein are applicable to analog devices without the need for local or temporal control and can be operated with measurements in only a single basis. However, the methods, systems, and devices described herein can also be applied to digital devices.

Embodiments of the inventive subject matter described herein can also be extended to quantum evolution over short times or shallow depth compared to existing protocols, providing utility in situations where deep quantum evolution is prohibited.

### First Example: Random State Generator

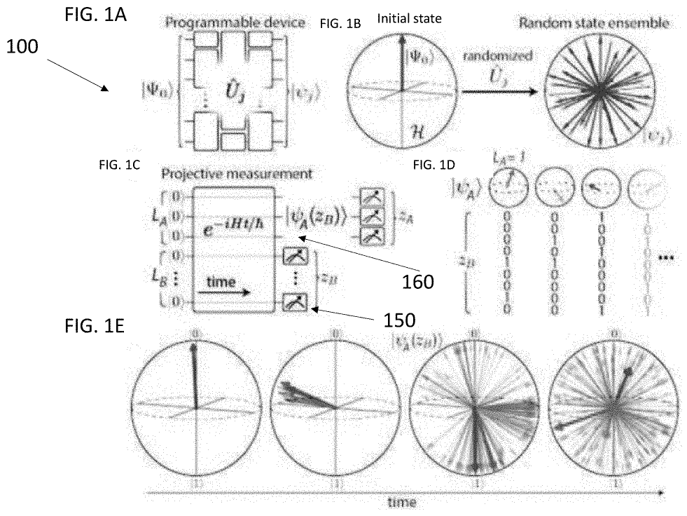

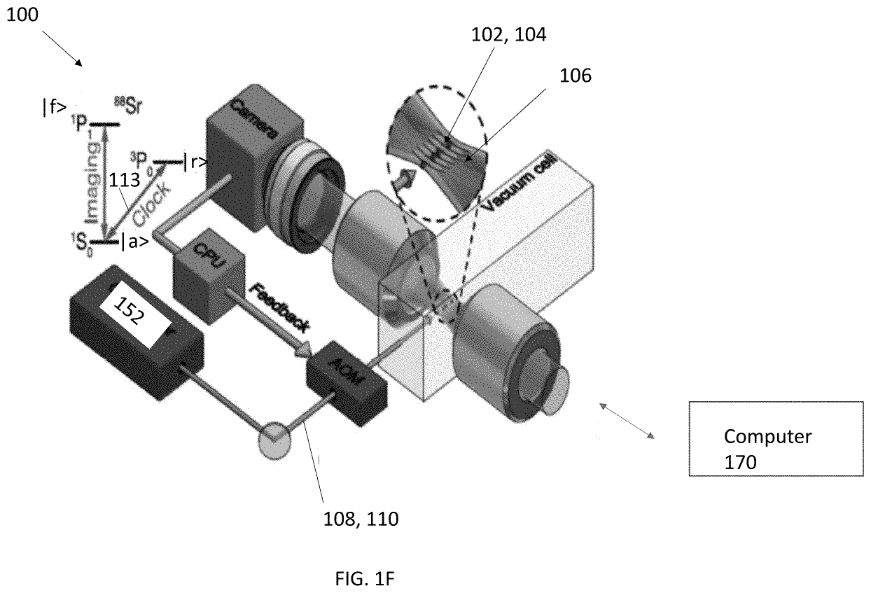

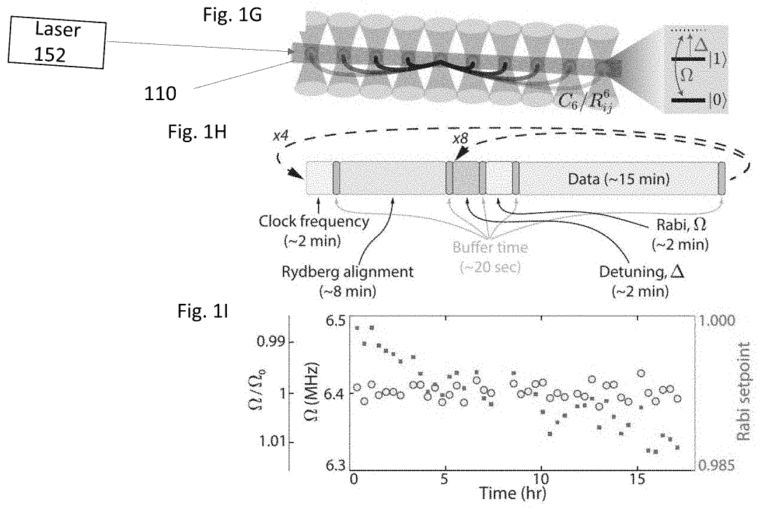

FIG. 1 illustrates a random state generator 100, comprising a plurality of coherently interacting quantum systems 102 (e.g., qudits or qubits) having a plurality of quantum degrees of freedom. The quantum systems may be prepared with (e.g., high) fidelity in a well characterized quantum state |Ψ₀ [symbol] for the quantum degrees of freedom. The random state generator further comprises a signal source coupled to the quantum systems configured to output one or more signals that quantum mechanically evolve the quantum state under the influence of couplings and the interactions between the quantum systems and/or between the quantum systems and a source of decoherence (e.g., noise), e.g., to form an evolved state |ψⱼ [symbol] .

In one or more examples, the quantum systems are prepared in with a fidelity, e.g., that does not change based on system size, that is greater than 0.00001, and/or that is better than can be classical simulation) in the well characterized quantum state |Ψ₀ [symbol] (e.g., a pure quantum state) for the quantum degrees of freedom.

Example quantum systems include, but are not limited to, neutral atoms, quantum dots, solid state defects, superconducting qubits/qudits.

Example quantum degrees of freedom include, but are not limited to, position and energy level (e.g., atomic level or spin state).

Example signal sources and signals include, but are not limited to, sources of electromagnetic radiation, e.g., lasers emitting coherent electromagnetic radiation (e.g., electromagnetic waves and/or fields) sources of acoustic fields or waves emitting acoustic fields or waves, sources of magnetic fields or waves, or sources of electric fields or waves.

Examples of coupling and interactions between the quantum systems include, but are not limited to, electrostatic fields, electromagnetic fields, magnetic fields, Van der Waals interactions (e.g., inducing Rydberg Blockade), dipole interactions, spin interactions. The couplings and interactions may be inherent to properties/energy level structure of the material system implementing the quantum systems or may be induced by external control or application of fields or forces, e.g., via a gating action. Couplings may comprise intensity/strength of laser electromagnetic field relative to the transition frequency evolving the quantum state or the transition frequency between the two states being driven.

In various examples, “couplings” refers to single-particle control by an external control field, and “interactions” refers to multi-particle control mediated by their mutual interaction.

Example noise sources include processes or interactions that induce decoherence or dissipation of the quantum state of the quantum system, either inherent to the material system or from the external environment.

FIG. 1 further illustrates the random state generator further comprises a detection system 150 for performing a measurement z_{B} on a subset B of the quantum systems, resulting in a second quantum state |ψ_{A}(z_{B}) [symbol] of the unmeasured quantum systems A. The subset of the quantum systems comprises a first plurality A of the quantum systems, and the unmeasured quantum systems comprise the remaining number B of the quantum systems. The second quantum state o|ψ_{A}(z_{B}) [symbol] f the unmeasured quantum systems is used as a source of one or more pseudo random quantum states that can be outputted from the random state generator at one or more outputs 160.

a. Example Experimental Implementation with Atoms

(ii) Rydberg Analog Quantum Simulator (see also [65] of references for first example)

FIGS. 1F and 1G illustrate a pseudo random state generator 100 implemented with quantum systems 102 comprising alkaline earth atoms 104 which provide high-fidelity preparation, evolution, and readout. The system comprises an array of (in this example, 35) optical tweezers 106 to trap a plurality of atoms (in this example, 18 individual Strontium-88 atoms) in trapping potentials.

The quantum systems each comprise one of the atoms comprising a first state |0 [symbol] and a second state |1 [symbol] . The signals 108 comprise coherent electromagnetic radiation 110 configured to (1) initialize the systems in the first state, and (2) quantum mechanically, evolve the systems by applying the coherent electromagnetic radiation continuously driving a transition between the first state and second state, under the influence of the coherent electromagnetic radiation driving the transition and the interactions (van der Waals interactions) between the atoms.

For the data presented in this example, the atoms initially in the 5s^{2 1}S₀ state are cooled on the 5s^{2 1}S₀↔5s5p³P₁ (689 nm) transition close to their motional ground state, with an average motional quanta of [symbol] n [symbol] ≈0.3 (corresponding to ≈3 μK). For all data shown, the initially stochastically filled array is rearranged to a defect-free array of 10 atoms spaced by 3.3 μm, discarding extras.

The system is initialized with one or more qubits in their ground state of the Rydberg atom. For the data in this example, atoms are initialized to the qubit ground state 5s5p³P₀ (698 nm) clock state |0 [symbol] through a combination of coherent drive and incoherent pumping, for a total preparation fidelity of 0.997(1). The metastable qubit ground state, |0 [symbol] is subsequently driven to the 5s61³S₁, mⱼ=0 (317 nm) Rydberg state, |1 [symbol] to evolve the system with a time-independent Hamiltonian, H, of the form

$$H = Ω {\sum }_{i} {S}_{i}^{x} - Δ {\sum }_{i} {n}_{i} + \frac{{C}_{6}}{{a}^{6}} {\sum }_{i > j} \frac{{n}_{i} {n}_{j}}{{\vert i - j \vert}^{6}}$$

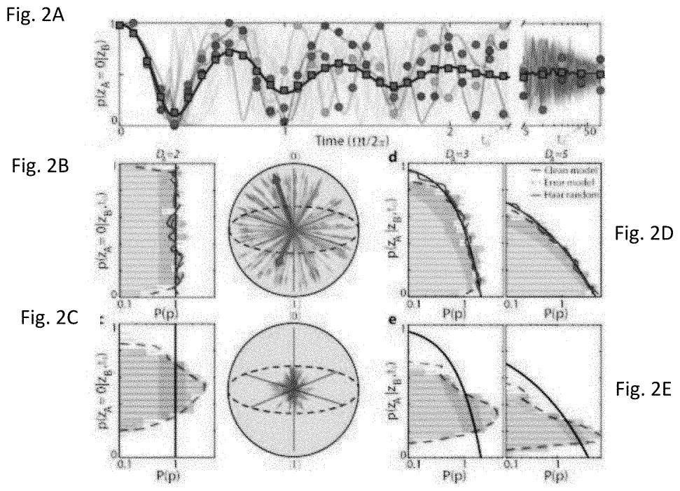

which describes a set of interacting two-level systems, labeled by indices i and j, driven by a laser with Rabi frequency Ω and detuning Δ. The interaction strength is determined by the C₆ coefficient and the lattice spacing a. Operators are Sᵢ^{x}=(|1 [symbol] ᵢ [symbol] 0|ᵢ+|0 [symbol] ᵢ [symbol] 1|ᵢ)/2 and nᵢ=|1 [symbol] ᵢ [symbol] 1|ᵢ, where |0 [symbol] ᵢ and |1 [symbol] ᵢ denote the electronic ground and Rydberg states at site i, respectively. For measurements observing the emergence of random ensembles (FIGS. 1 and 2), the following parameters are selected: Ω/2π=4.7 MHz, Δ/2π=0.9 MHz, a=3.3 μm, and an experimentally measured interaction coefficient of C6=126(2) GHz μm⁶. Under this condition, the initial all-zero state rapidly thermalizes to an infinite-temperature thermal ensemble locally. The C₆ value is independently estimated by measuring the interaction-induced energy shift V=C₆/R⁶ at various distances R between two atoms prepared in the Rydberg state.

Following Hamiltonian evolution, state readout is performed, in this example using the auto-ionizing transition 5s61³s₁, mⱼ=0 ↔5p_{3/2}61s_{1/2} (408 nm, J=1, mⱼ=±1) which rapidly ionizes atoms in the Rydberg state with high fidelity (≈0.999), leaving them dark to the fluorescent imaging. Atoms in the clock state are pumped into the imaging cycle, allowing direct mapping of the atomic fluorescence to the qubit state.

As the experimental data shown requires both high statistics (taken over the course of multiple days) and very fine parameter control, automatic feedback is performed to the Hamiltonian parameters of Rabi frequency and detuning using a home-built control architecture. Specifically these are: 1) the clock state resonance frequency to ensure maximal preparation fidelity, 2) the Rydberg laser beam alignment, 3) the Rydberg resonance frequency, and 4) the Rydberg Rabi frequency. For the clock frequency, a π-pulse is applied on the clock transition to identify the resonance and perform state-resolved readout by ejecting all ground state atoms from the trap with an intense pulse of light on the 5s^{2 1}S₀↔5s5p¹P₁ (461 nm) transition.

For the Rydberg alignment, detuning, and Rabi frequency, the array is rearranged to ≈8 non-interacting atoms spaced by 13.3 μm. During alignment, the Rydberg beam is rastered across the array sampling different position-dependent Rabi frequencies, and thus evolving to different position-dependent phases. The resultant signal across all positions is compared to a simulation to identify the point of furthest phase, and thus maximal intensity. For the Rydberg detuning, the resonance condition at Ωt=13π is measured in order to narrow the resonance feature. For the Rabi frequency, a series of time points between 13π<Ωt<17π, are taken and the resulting Rabi oscillations are fitted. Such times are used to minimize the effect of pulse turn on and turn off while limiting decoherence effects. After each feedback experiment, the relevant parameter is updated for subsequent measurements (FIG. 1G).

(iii) Experimental Results

After a variable evolution time, site-resolved readout is performed in a fixed measurement basis, yielding experimentally measured bitstrings, z. To probe the projected ensembles for various possible subsystems A and complements B, these are bi-partitioned into bitstrings z_{A} and z_{B}.

Hamiltonian parameters are chosen such that, after a short settling time, the marginal probability of measuring a given z_{A} (while ignoring the complementary z_{B}) agrees with the prediction from \hat{ρ}_{A} being a maximally mixed state. In the language of quantum thermalization^{15,39-44}, this prediction is equivalent to saying \hat{ρ}_{A} has reached an equilibrium at infinite effective temperature with the complement B as an effective, intrinsic bath^{15,16,45}. For a single qubit in A, such a reduced density operator is

$${\hat{ρ}}_{A} = \frac{1}{2} ( \vert 0 〉 〈 0 \vert + \vert 1 〉 〈 1 \vert )$$

the quint has a probability of being in state |0 [symbol] of p(z_{A}=0)=1/D_{A}=0.5, where D_{A}=2 is the local dimension of A. As shown in FIG. 2a, after a short transient period the experimentally measured probabilities, p(z_{A}=0) (grey squares), equilibrate in agreement with this prediction. Post-selection is applied in accordance with the Rydberg blockade constraint.

This equilibration is contrasted with the dynamics of conditional probabilities, p(z_{A}|z_{B}), of measuring a given z_{A} conditioned on finding an accompanying measurement outcome in the intrinsic bath, z_{B}; note the marginal probability for finding z_{A} is the weighted average over conditional probabilities, p(z_{A})=Σ_{z}_{_{B}}p(z_{B})p(z_{A}|z_{B}). More generally, while p(z_{A}) yields information of the reduced density operator, such conditional probabilities yield signatures of the projected ensemble, as p(z_{A}|z_{B})=| [symbol] (z_{A}|ψ_{A}(z_{B}) [symbol] |². FIG. 2A plots numerically simulated p(z_{A}=0|z_{B}) (grey lines), with selected traces (highlighted in color) and their corresponding experimental data (circle markers). The conditional probabilities are found to be highly fluctuating in a seemingly chaotic fashion with sensitive dependence on z_{B}, even when the marginal probability has reached a steady state. In experiments, FIG. 2B shows these fluctuations slowly damp out over time due to extrinsic decoherence effects from coupling to an external environment at very late time, but that these decoherence effects do not appear to affect the late-time marginal probability.

To analyze fluctuations quantitatively, FIG. 2B plots a histogram P(p) of finding the conditional probability p(z_{A}|z_{B}) in an interval [p, p+Δp], with Δp the bin size. The histograms are plotted for a time when fluctuations are strong and decoherence effects are small (t₀, FIG. 2b) as well as at very late time (t₁, FIG. 2c) when decoherence dominates. At t₀, the experimental P(p) distribution is essentially flat, as predicted for a Haar-random ensemble, up to finite-sampling fluctuations and weak decoherence effects⁴⁶. FIG. 2b additionally shows projected states obtained from simulation (Bloch sphere in FIG. 2b) to illustrate how such a flat distribution is generated from a near-uniform ensemble of states. At very late time, t₁, decoherence effects reduce the purity of projected states significantly, leading to P(p) becoming concentrated around 1/D_{A}=0.5 (FIG. 2c). This highlights that the agreement between the experimental data and the random ensemble prediction in the FIG. 2b,d is a coherent phenomenon of closed quantum system dynamics. FIG. 2D further validates this in FIG. 2D,E by plotting the P(p) for subsystems with larger Hilbert space dimensions of D_{A}=3 and 5 (Methods). Here, the prediction from the Haar-random distribution⁵ is P(p)=(D_{A}−1)(1−p)^{D}^{_{A}}⁻², which in the limit D_{A}→∞, becomes the well-known Porter-Thomas distribution⁴⁷, P(p)=D_{A}e^{-D}^{_{A}}^{p}, a key signature of the formation of random state ensembles.

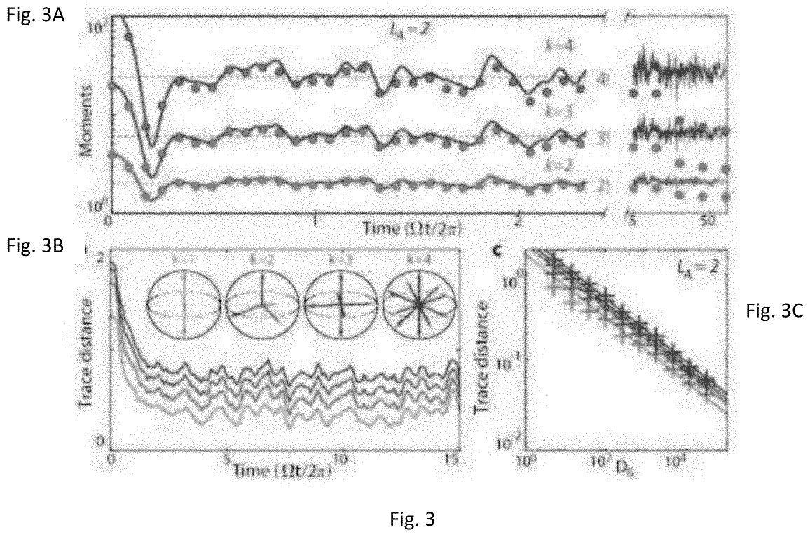

FIG. 3A considers moments of the distributions P(p), where the kth moment is defined as p^{(k)}=Σₚp^{k}P(p) (FIG. 3a). It is found that after rescaling by a factor of D_{A} . . . (D_{A}+k−1), moments from both experiment and numerics quickly approach the analytical result expected from a Haar-random ensemble⁴⁶. Again, at very late time, moments show a characteristic drop, indicating sensitivity to decoherence effects (FIG. 3a, right). The convergence to k 12 is independent of the details of subsystem selection, whether A is chosen at the edge, center, or is even discontiguous, and universal values are also found for two-point correlators⁴⁶. While this analysis has been carried out solely for the projected ensemble equilibrated to infinite effective temperature, signatures of similar universal behavior are seen numerically for finite effective temperature cases^{17,46}.

It is possible to quantify the degree of randomness in the projected ensemble by a notion of ‘distance’ not between observables, but between the ensembles themselves. To do so, the projected ensemble is compared against progressively more complex approximations to the uniformly random state ensemble k-designs⁴⁸. FIG. 3B shows that for the case of a single qubit, such k-designs are increasingly complex distributions of states on the Bloch sphere, realizing the uniform random ensemble for k→∞. For comparison, FIG. 3C shows the trace distance between the projected ensemble, generated from error-free simulation, and successive k-designs; a vanishing distance implies the projected ensemble and the uniform random ensemble are indistinguishable for any observables up to order k, including the moments p^{(k)} from FIG. 3A. The distances decrease for all k th orders as a function of time, before saturating to a value exponentially small in the total system size (FIG. 3C). Similar numerical results are found for the case of random unitary circuits and a Hamiltonian used in ion trap experiments.

### Second Example: Benchmarking Quantum Devices

a. Characterizing Coupling Strength

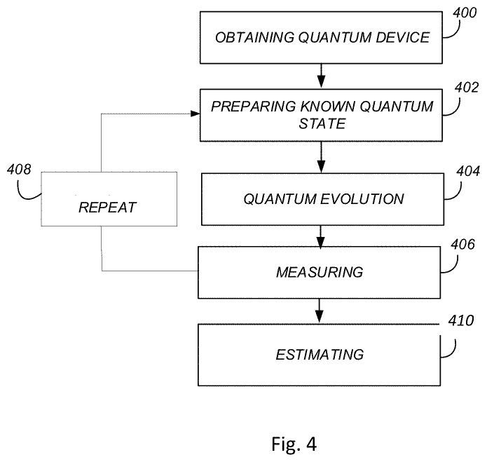

FIG. 4 is a flowchart illustrating a method to characterize coupling strength among quantum systems and/or between a source of decoherence and the quantum systems (referring also to FIGS. 1-13).

Block 400 represents obtaining a quantum device comprising quantum systems 102 each having multiple quantum degrees of freedom (e.g., position, energy levels). Example quantum systems include those described with reference to the first example.

Block 402 represents preparing a well characterized (e.g., pure) quantum state |ψ₀ [symbol] , |0 [symbol] of the quantum systems with a (e.g., high) fidelity. This may be achieved by application of appropriately configured first signals. In one or more examples, the prepared fidelity does not change based on system size, is greater than 0.00001, and/or is better than can be achieved with a classical simulation.

Block 404 applying one or more appropriately configured second signals to quantum mechanically evolve the well defined/characterized quantum state under influence of the couplings (e.g., laser field) and interactions (e.g., van der Waals). Example signals in Block 302 and 304 include, but are not limited to, those signals described with reference to the first example. Appropriate configuration of the signals may include selecting a frequency, pulse duration (e.g., pi-pulse), amplitude, or phase of the signals.

Block 406 represents performing a measurement z on all the quantum degrees of freedom of the quantum systems in the evolved state ρ(t), resulting in a particular measurement sample z of the quantum state formed in Block 406.

Block 408 represents repeating the steps of Blocks 302-306 obtain a plurality of measurement samples z.

Block 410 represents comparing the measurement samples against expected behavior with time evolution obtained using modeling using a classical computer, to estimate the strength of the couplings.

b. Characterizing Fidelity

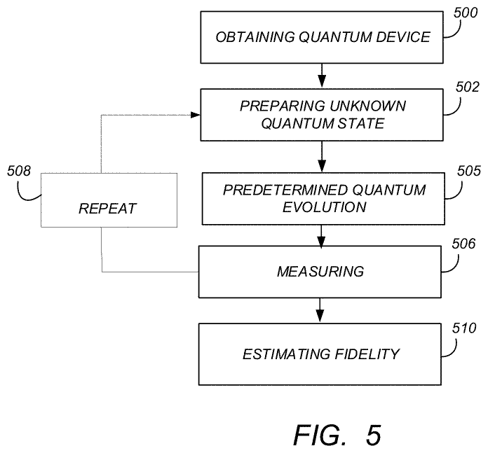

FIG. 5 is a flowchart illustrating a method of characterizing fidelity of a quantum state of interest (referring also to FIGS. 1-13).

Block 500 represents obtaining a quantum device comprising quantum systems comprising multiple quantum degrees of freedom (e.g., energy levels, position). Example quantum devices and quantum systems 102 include those described in the first example.

Block 502 represents preparing a quantum state of interest |Ψ₀ [symbol] , of the quantum systems 102, wherein the quantum state of interest is prepared with unknown fidelity. This may be achieved by application of appropriately configured first signals.

Block 504 represents applying appropriately configured second signals to quantum mechanically evolve the quantum state of interest in a predetermined, specific manner (e.g., known time duration) and under influence of well characterized couplings and interactions. Example types of signals in Block 502 and 504 include those signals described in the first example. Appropriate configuration of the signals may include selecting a frequency, pulse duration (e.g., pi-pulse), amplitude, or phase of the signals.

Block 506 represents performing measurement on all the quantum degrees of freedom of the evolved quantum state of interest ρ(t) resulting in a particular measurement sample z of the evolved quantum state.

Block 508 represents repeating steps of Blocks 502-506 to obtain a plurality of measurement samples.

Block 510 represents comparing the measurement samples against expected behavior with time evolution, obtained using a model solved using a classical computer, to estimate the fidelity F of the quantum state of interest.

c. Simultaneous Characterization of Coupling Strength and Fidelity

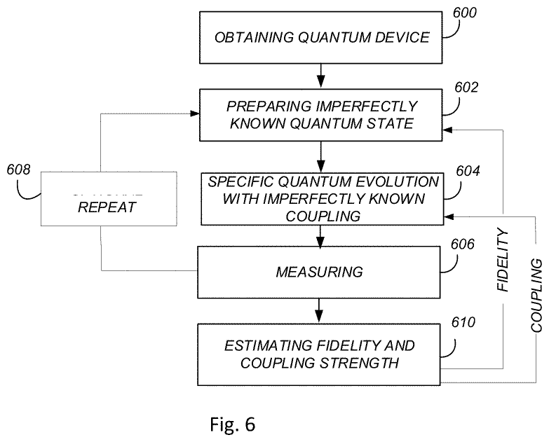

FIG. 6 illustrates a method of characterizing a quantum system by simultaneous characterization of the coupling strength J and fidelity F. The method comprises the following steps (referring also to FIGS. 1-13).

Block 600 represents obtaining a quantum device comprising quantum systems comprising multiple quantum degrees of freedom. Example quantum systems include those described in the first example.

Block 602 represents preparing an initial quantum state, wherein the initial quantum state is initially imperfectly known (imperfect knowledge of fidelity).

Block 604 represents applying appropriately configured second signals to quantum mechanically evolve the quantum state of interest in a predetermined, specific manner (e.g., known time duration) and under influence of imperfectly known couplings and interactions.

Block 606 represents performing measurement on all the quantum degrees of freedom of the evolved quantum state of interest resulting in a particular measurement sample z of the evolved quantum state.

Block 608 represents repeating steps of Blocks 602-608 to obtain a plurality of measurement samples.

Block 610 represents comparing the measurement samples against expected behavior with time evolution, obtained using a model solved using a classical computer, to estimate:
the fidelity of the quantum state of interest, wherein the estimate of the fidelity is used as an input to provide knowledge of the fidelity of the quantum state in Block 602;
and the strength of the couplings, wherein the estimate of the strength of the couplings is used to update/provide knowledge of the strength of the coupling in Block 604;
so that the method simultaneously estimates the fidelity of the initial state and the strength of the couplings.

In another example, the methods of FIG. 4 and FIG. 5 are prepared simultaneously, wherein the initial state prepared in step 402 of FIG. 4 is initially imperfectly known, knowledge of the couplings in step 504 of FIG. 5 is initially imperfect, estimation of the fidelity obtained from Block 510 is used as an input to provide knowledge of the fidelity in Block 402 and estimation of the coupling obtained in Block 410 is used to provide the knowledge of the coupling in Block 504, so that performance of the methods to benchmark coupling strength and fidelity simultaneously estimates the fidelity of the initial state in Block 402 and the strength of the couplings used in Block 502.

d. Example System for Benchmarking (See Also [65] of References for First Example)

(i) Formulation of an Estimator

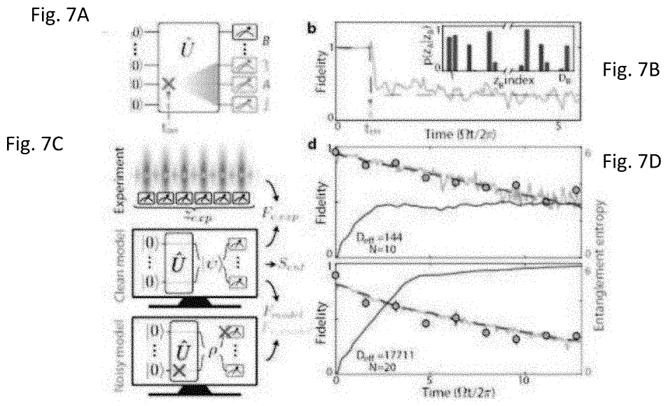

The sensitivity of the projected ensemble to decoherence was used to benchmark the evolution of an experimental system under a time-independent Hamiltonian; crucially, in one or more embodiments, our approach would be impossible with access only to the reduced density operator as it is relatively insensitive to decoherence (FIG. 2). As an example, the case of a single error occurring at time tₑᵣᵣ during unitary evolution is considered. The effect of this error then propagates outward⁴⁹, generically transforming the evolution output state and affecting measurement outcomes in subsystem A (FIG. 7a,b). Using the fact that the projected ensemble forms an approximate 2-design^{4,5,9,18,22,23}, a fidelity estimator Fₑ is designed to detect and quantify the effect of this error. The Fₑ estimator effectively quantifies a rescaled cross-correlation between measurement probabilities in the experimental and ideal conditions:

$${F}_{c} = 2 \frac{{\sum }_{s} {p}_{0} ( z ) p ( z )}{{\sum }_{s} {p}_{0}^{2} ( z )} - 1$$

where p(z) and p₀(z) are the experimental and theoretical probabilities of observing a global bitstring z, respectively. Numerical methods confirms that shortly after an instantaneous phase rotation error is applied on one qubit, the estimator approximates the many-body state overlap, Fₑ≈F= [symbol] ψ(t)|\hat{ρ}(t)|ψ(t) [symbol] , between the ideal state, |ψ [symbol] , and the erroneous state, \hat{ρ} (FIG. 7b,)⁴⁶.

To evaluate Fₑ experimentally, an empirical, unbiased estimator:

$${F}_{c} \approx 2 \frac{\frac{1}{M} {\sum }_{i = 1}^{M} {p}_{0} ( {z}_{exp}^{( i )} )}{{\sum }_{s} {p}_{0}^{2} ( z )} - 1$$

where M is the number of sampled experimental bitstrings, zₑₓₚ. While this reformulation still requires calculation of a reference theory comparison, the required number of experimental samples to accurately approximate Fₑ scales favorably with system size N; the standard deviation of Fₑ is estimated to be σ(Fₑ)≈1.05^{N}/\sqrt{M}, indicating that we do not need to fully reconstruct the experimental probability distribution for fidelity estimation of large quantum systems.

(ii) Experimental Implementation on Rydberg Simulator of the First Example

The benchmarking protocol was tested for errors occurring continuously with a Rydberg quantum simulator of up to 20 atoms. The fidelity of the experimental device, F_{e,exp} is estimated by correlating measured bitstrings to results from error-free simulation as a function of evolution time. In addition, an ab initio error model is used with no free parameters that mimics the experimental output⁴⁶, from which we extract both the fidelity estimator, F_{e,model}, and the model fidelity, F_{model}= [symbol] ψ(t)|\hat{ρ}_{model}(t)|ψ(t) [symbol] (FIG. 7c).

FIG. 7D compares F_{model}, F_{e,exp}, and F_{e,model} for system sizes of ten and twenty atoms, showing F_{e,model}≈F_{model}, validating the efficacy of the estimator under realistic error sources. It is also found that F_{e,exp}≈F_{e,model}, and that bitstring probability distributions show good agreement between the error model and the experiment for N=10, indicating that our ab-initio error model is a good description of the experiment⁴⁶.

It is numerically shown that Fₑ also applies for erroneous evolution using other quantum devices, specifically with random unitary circuits and Hamiltonian evolution in an ion trap quantum simulator. In the case of circuits, Fₑ accurately estimates the fidelity at much shorter evolution times than do existing methods such as linear-cross entropy benchmarking^{3,5}, consistent with the early-time formation of the projected ensemble (FIG. 2). By contrasting entanglement growth and fidelity decay, a direct comparison can be made between analog quantum simulators and digital quantum computers. For the digital gate-set used in Ref.⁵, the Rydberg quantum simulator has an equivalent effective fidelity as a digital quantum device with a per-qubit state-preparation-and-measurement (SPAM) fidelity of 0.995(1), and a two-qubit cycle fidelity of 0.988(1). This value is non-universal and depends on the choice of gate-set in the digital quantum circuit.

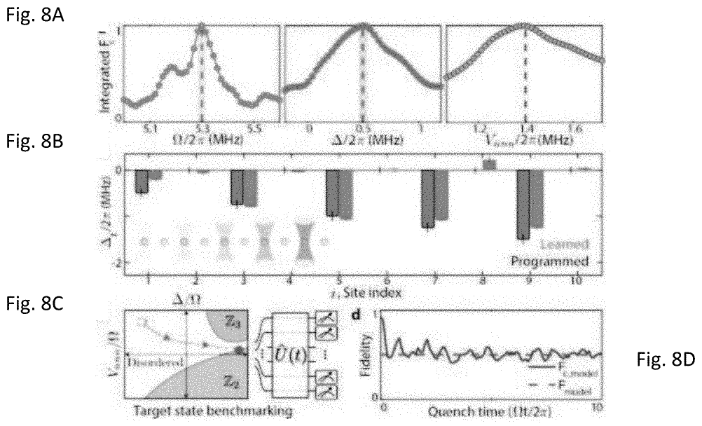

This protocol is used for in situ estimation of multiple Hamiltonian parameters simultaneously. The Hamiltonian in simulation is systematically varied and the resulting Fₑ is monitored to find the parameters which show the best agreement between numerical and experimental evolution. For example, a family of target states can be defined, which are parameterized by the Rabi frequency, Ω, as |ψ(t, Ω) [symbol] =e^{-itĤ(Ω)/ℏ}|0 [symbol] ^{⊗N}. When the value of Ω does not match the Rabi frequency used in the experiment, the target state |ψ(t, Ω) [symbol] will have smaller overlap with the experimental state, and the fidelity estimator Fₑ(t, Ω)≈ [symbol] ψ(t, Ω)|\hat{ρ}(t)|ψ(t, Ω) [symbol] will decay more quickly. To capture this effect in a single quantity, FIG. 8A plots the normalized, time-integrated Fₑ. For each Hamiltonian parameter, a sharp maximum emerges⁴⁶, showing good agreement with precalibrated values (dashed lines and shaded areas). Parameter estimation also works when applied to learn local, site dependent terms of a disordered Hamiltonian (FIG. 8b).

The benchmarking protocol can be extended to benchmark the fidelity of preparing various quantum states of interest by preparing a target state and then quenching the Hamiltonian to evolve the prepared state at effective infinite temperature (FIG. 8c). As a numerical proof-of-principle, we show results for such target state benchmarking to prepare a ground state near the Ising quantum phase transition in the Rydberg models^{50,51} (FIG. 8c,d), where the ‘noisy’ state is a equal probability mixture of the ground and first excited states. After a short disordered quench, the estimator Fₑ reveals the fidelity of the prepared state, offering a novel way to perform in situ optimization of many-body state preparation.

### Third Example: Further Fidelity Testing Examples (See Also [69] of References for Third Example)

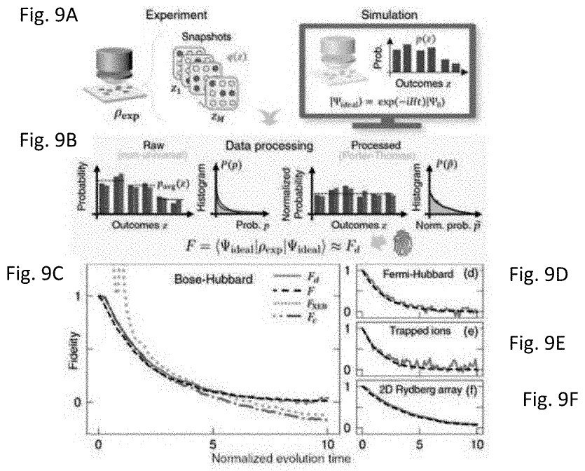

An example protocol consists of three basic steps: experiment, simulation, and data processing. See Table I and FIG. 9(a,b).

TABLE 1
Benchmarking Protocol

| Experiment: | | |
|---|---|---|
| | 1. | Prepare an initial state \|Ψ₀ [symbol] . |
| | 2. | Evolve the system under its natural Hamiltonian |
| | | H for time t. |
| | 3. | Measure the evolved state ρ(t) in a natural basis |
| | | to obtain configurations {zⱼ}ⱼ₌₁^{M}. |
| Simulation: Classically compute: | | |
| | 1. | p(z, t) ≡ \| [symbol] z\| exp(−iHt) \|Ψ₀ [symbol] \|², |
| | 2. | ${p}_{avg} ( z ) ≡ {lim}_{T \to ∞} \frac{1}{T} {\int }_{0}^{T} p ( z , t ) dt ,$ |
| | 3. | \tilde{p}(z, t) = p(z, t)/p_{avg}(z). |

| Data processing: Evaluate an unbiased estimator, | |
|---|---|
| | ${\tilde{F}}_{d} ≡ \frac{2}{{\sum }_{z} {p}_{avg} ( z ) {\tilde{p} ( z , t )}^{2}} [ \frac{1}{M} {\sum }_{i = 1}^{M} \tilde{p} ( {z}_{i} , t ) ] - 1 ,$ |

for our benchmark F_{d} in Eq. (1), which approximates
the fidelity F = [symbol] Ψ₀| e^{iHt} ρ(t)e^{-iHt} |Ψ₀ [symbol] .

In the experiment, the initial state of the quench dynamics can either be an easy-to-prepare fiducial state or a more complex state that one wishes to benchmark. Measurements can be done in the most natural basis {|z [symbol] } of a given hardware, as long as all possible measurement outcomes form a complete basis, e.g. particle number configurations in quantum gas microscopes. Repeating M times, one measures configurations {z₁, . . . , z_{M}}, where each zᵢ is sampled from the probability distribution q(z,t)≡ [symbol] z|ρ(t)|z [symbol] .

Classically simulating the same process gives the theoretical distribution p(z, t) and its infinite time-average p_{avg}(z)[39]. In practice, one may approximate p_{avg}(z) by averaging p(z, t) over a finite duration.

The experimental data and theory predictions can be compared using the benchmark

$${F}_{d} ( t ) ≡ 2 \frac{{\sum }_{z} {p}_{avg} ( z ) \tilde{q} ( z , t ) \tilde{p} ( z , t )}{{\sum }_{z} {p}_{avg} ( z ) {\tilde{p} ( z , t )}^{2}} - 1$$

where \tilde{p}(z, t) and \tilde{q}(z, t)≡q(z, t)/p_{avg}(z) are normalized outcome probabilities from theory and experiment respectively. F_{d} can be efficiently evaluated by using the unbiased estimator in Table I. The number of requisite samples are analyzed below. F_{d} approximates the fidelity F for a wide class of quantum systems, when the amount of error is reasonably small and not strongly correlated [35, 40-42].

FIG. 9(c-f) numerically demonstrates our quantum process benchmarking, where F_{d} indeed successfully traces the fidelity decay in four different quantum simulation platforms. For each platform, the system initialized in a simple product state is considered, undergoing its natural Hamiltonian dynamics with realistic parameters in the presence of experimentally relevant errors [35].

Speckle-based benchmarking.—The salient and surprising feature of our protocol is that the fidelity can be estimated from measurement data obtained in a fixed basis, despite the fact that the overlap depends on phase information inaccessible from these measurements. Indeed, an instantaneous phase error may change F but not F_{d}. Nevertheless, owing to the combination of operator scrambling and emergent universal statistics, F_{d} still approximates F for generic quantum states produced in our protocol.

This can be seen by review of the qualitative mechanism of another approach: the linear cross-entropy benchmark (XEB)[36]F=_{XEB}≡DΣ_{z}q(z)p(z)−1 estimates the fidelity of running RUCs on an N-qubit system with Hilbert space dimension D. When a typical output state from a deep RUC is measured, its outcome distribution p(z) is not perfectly uniform, but exhibits a speckle pattern: over different z's, p(z) fluctuates around 1/D due to random interference from coherent quantum dynamics. While the detailed pattern of the fluctuations—which p(z)'s are relatively larger—sensitively depends on the choice of a particular RUC, the amount of fluctuation is universal: Σ_{z}p²(z)≈2/D. In fact, all statistical properties of {p(z)}_{z} are universal: viewing p(z) for each z as an independent sample of a random variable, {p(z)}_{z} follows the so-called Porter-Thomas (PT) distribution [35,36].

Crucially, the speckle pattern may serve as a fingerprint of a quantum state since any local error drastically changes the pattern with high probability. When an error occurs in chaotic dynamics, its subsequent time evolution scrambles the error operator into a complicated nonlocal form [37, 38]. This operator scrambling allows for the detection of even phase errors, which are diagonal in the measurement basis. The scrambled operator leads to a new probability: q(z)=Fp(z)+(1−F)p_{⊥}(z) where the second term is uncorrelated with the original pattern, Σ_{z}p(z)p_{⊥}(z)≈1/D with high probability [41]. In fact, as a function of time after the error, it is exponentially unlikely that p_{⊥} and p are correlated [40]. Then, it follows from the universal fluctuation that F_{XEB}=F+O(1/D). It has been rigorously shown that the XEB approximates the fidelity for deep RUCs as long as errors are sufficiently weak (or occur sparsely) and uncorrelated [40-43].

For shallow circuits, however, the XEB is not applicable since the resultant {p(z)}_{z} does not exhibit the universal fluctuation. Recently this limitation was alleviated by a new formula Fₑ≡2Σ_{z}q(z)p(z)/Σ_{z}p(z)²−1 [34]. A key idea is that, even for relatively short time evolution, universal fluctuations can still emerge locally in the conditional distribution of local measurement outcomes under certain conditions such as shallow RUCs or chaotic Hamiltonian dynamics at infinite effective temperature without any symmetries [34, 44].

Under realistic Hamiltonian evolution away from infinite temperature, the universal PT distribution is obtained neither globally nor locally. The presence of energy conservation or other symmetries leads to certain systematic patterns in {p(z)}_{z}, distorting its distribution away from PT. For example, for any state with positive effective temperature, lowenergy configurations are more likely to be measured. Similarly, the presence of symmetries may bias measurement outcome distributions [35]. For this reason, F_{XEB} or Fₑ deviates from F in generic quantum simulators as shown in FIG. 9(c).

The generalized benchmarking protocol is enabled by a new finding: in spite of nonuniversal systematic patterns in {p(z)}_{z}, universal statistics can be recovered via appropriate data processing. Specifically, the systematic pattern is captured by the time-averaged factor p_{avg}(z). Hence, normalizing p(z) with p_{avg}(z) leaves only random fluctuations, unveiling the desired statistical properties. This is described by the following theorem:

Consider an initial state |Ψ₀ [symbol] and a Hamiltonian H satisfying the k-th no-resonance condition for a large integer k. Then, the normalized probabilities \tilde{p}(z)≡p(z)/p_{avg}(z) approximately follow the Porter-Thomas distribution at late times, up to a correction bounded by the effective Hilbert space dimension D_{β}, where D_{β}⁻¹≡Σz,E [symbol] z|E [symbol] |⁴| [symbol] E|Ψ₀ [symbol] |⁴/p_{avg}(z) and {|E [symbol] } are the energy eigenstates of H.

A similar statement holds for \tilde{p}(z)'s with a fixed z evaluated at different evolution times. See [35] for proof. Our theorem only relies on the k-th no-resonance condition, which states that the eigenvalues {Eⱼ} of H possess no resonant structures. That is, Σᵢ₌₁^{k}Eαᵢ=Σᵢ₌₁^{k}Eβᵢ if and only if the k indices (αᵢ) are a permutation of (βᵢ) [45-49]. This no-resonance condition is expected to hold for generic ergodic Hamiltonians [45,46]. The effective Hilbert space dimension D_{β} quantifies the degree of ergodicity of the quench evolution, and is generically exponentially large in system size, enabling high accuracy in our protocol. The required k-th no-resonance condition is weaker than demanding the ergodicity of H in its full Hilbert space; some interacting integrable systems satisfy this condition. Thus, our protocol is applicable even for such systems, as demonstrated with a 1D Fermi-Hubbard model at half-filling in FIG. 9(c) [35, 50].

Our benchmark F_{d} utilizes these universal properties to estimate F in the same way as F_{XEB} and Fₑ. For example, assuming an ansatz \tilde{q}(z)=F\tilde{p}(z)+(1−F)\tilde{p}_{⊥}(z), the relation F_{d}≈F can be easily shown. Moreover, F_{d} reduces to Fₑ and F_{XEB}, under appropriate limiting cases. In fact, we can relax the above ansatz and still prove F_{d}≈F by using the Eigenstate Thermalization Hypothesis and the k-th no-resonance condition at late times [35, 51]. From extensive numerical simulations, it is also found that F_{d}≈F holds even for relatively short quench evolution well before the PT distribution emerges from the global probabilities, similar to the case of Fₑ[FIG. 9(c,d) and SM] [34].

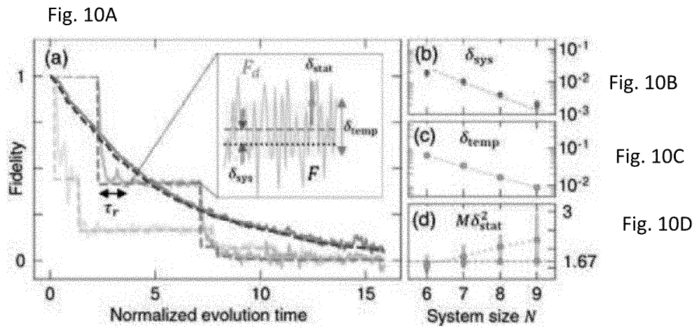

Having established the working principles of F_{d}, its performance can also be characterized. It can be shown that it suffices to study the effect of a single error. As a representative example, we consider noisy dynamics of the Bose-Hubbard model and investigate the evolution of a mixed state by unravelling it into an ensemble of stochastic pure state trajectories [52], where each trajectory corresponds to a fixed occurrence of errors. FIG. 10A shows that when a single error occurs, the fidelity decreases instantly, and F_{d} follows this decrease after a short time. This delay time τᵣ arises from the time needed for an error to be scrambled such that it can be detected in a fixed measurement basis. FIG. 10A further shows that averaging over trajectories gives the overall fidelity and F_{d} of the mixed state dynamics. As long as the error rates are sufficiently small, the presence of multiple errors does not lead to a qualitatively different behavior [40,41]. The finite delay time may lead to a slight overestimation of the fidelity when it decays continuously over time [35,40,53]; this may be corrected by careful characterization of τᵣ.

Given a single error, the performance of our benchmark is quantified along three different axes: systematic errors, temporal fluctuations, and statistical fluctuations. The systematic error δ_{sys} refers to the difference between the true fidelity and our benchmark averaged over time. The temporal fluctuation δₜₑₘₚ quantifies the fluctuation of our benchmark in time. The statistical fluctuation δₛₜₐₜ measures the standard deviation of the unbiased estimator \hat{F}_{d} associated with a finite number of samples M, which determines the so-called sample complexity Mδₛₜₐₜ² [FIG. 10(a) inset].

For quench Hamiltonians satisfying the k-th noresonance conditions, our Theorem enables us to analytically estimate the size of these errors and fluctuations [35], finding that both δ_{sys} and δₜₑₘₚ are O(D_{β}⁻¹) and O(D_{β}^{-1/2}) respectively, determined by the correction term in our Theorem. This implies that both the accuracy and precision of our benchmark improve exponentially with increasing system size. This scaling is confirmed in our numerical simulations [FIG. 10(b,c)].

The sample complexity Mδₛₜₐₜ² depends on the duration of the quench time and generally decreases (improves) for longer evolution. In the limit of long evolution, Mδₛₜₐₜ²≈1+2F−F², independent of system size [FIG. 10(d), dashed line]. This sample complexity shows an optimal system-size scaling and is equal to that of the best known approach based on randomized measurements [27]. For relatively short time evolution, the sample complexity grows weakly with system size [FIG. 10(d), dotted line]. While our protocol is applicable to generic quantum many-body systems, it may fail in some special cases. described in [69].

### Fourth Example: Estimation of Other Parameters Such as Coupling Strength (See Also [69] of References for Fourth Example)

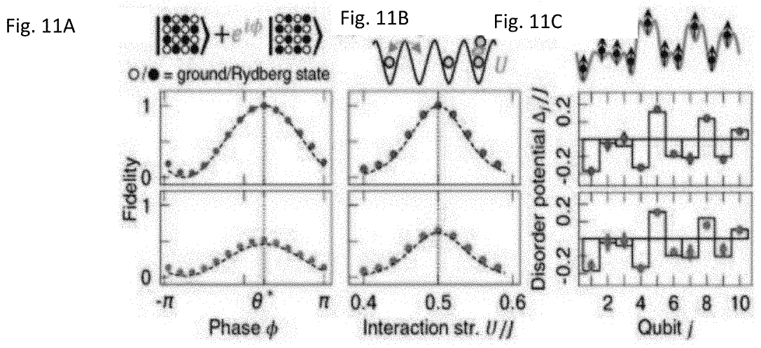

The ability to measure fidelity enables other applications, such as estimating multiple parameters of quantum states or Hamiltonians, in situ and simultaneously. A key observation is that given the ability to measure the fidelity between a theory prediction and experimental data, one can variationally optimize parameters in theory to maximize the estimated fidelity [34, 60]. FIG. 11 shows the numerical demonstration of this idea for (i) measuring the phase in a GHZ like state by quench evolving the state of interest under a 2D Rydberg blockaded model, and (ii) identifying the interaction strength in a Bose Hubbard model, and (iii) simultaneously determining ten disordered on site potentials in a spin chain model. The optimized parameters approximately match the true values even when the quench evolutions are noisy, demonstrating robustness.

Hardware Environment

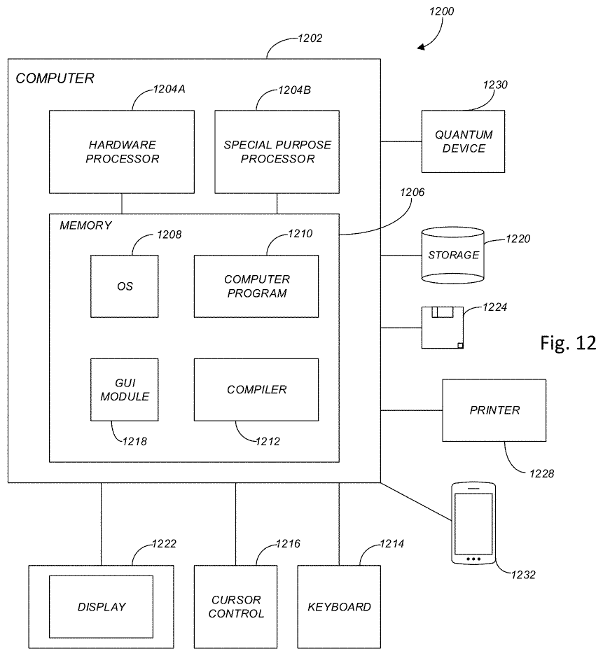

FIG. 12 is an exemplary hardware and software environment 1200 (referred to as a computer-implemented system and/or computer-implemented method) used to implement one or more embodiments of the invention. The hardware and software environment includes a computer 1202 and may include peripherals. Computer 1202 may be a user/client computer, server computer, or may be a database computer. The computer 1202 comprises a hardware processor 1204A and/or a special purpose hardware processor 1204B (hereinafter alternatively collectively referred to as processor 1204) and a memory 1206, such as random access memory (RAM). The computer 1202 may be coupled to, and/or integrated with, other devices, including input/output (I/O) devices such as a keyboard 1214, a cursor control device 1216 (e.g., a mouse, a pointing device, pen and tablet, touch screen, multi-touch device, etc.) and a printer 1228. In one or more embodiments, computer 1202 may be coupled to, or may comprise, a portable or media viewing/listening device 1232 (e.g., an MP3 player, IPOD, NOOK, portable digital video player, cellular device, personal digital assistant, etc.). In yet another embodiment, the computer 1202 may comprise a multi-touch device, mobile phone, gaming system, internet enabled television, television set top box, or other internet enabled device executing on various platforms and operating systems. In one embodiment, the computer 1202 operates by the hardware processor 1204A performing instructions defined by the computer program 1210 (e.g., a computer-aided design [CAD] application) under control of an operating system 1208. The computer program 1210 and/or the operating system 1208 may be stored in the memory 1206 and may interface with the user and/or other devices to accept input and commands and, based on such input and commands and the instructions defined by the computer program 1210 and operating system 1208, to provide output and results.

Output/results may be presented on the display 1222 or provided to another device for presentation or further processing or action. In one embodiment, the display 1222 comprises a liquid crystal display (LCD) having a plurality of separately addressable liquid crystals. Alternatively, the display 1222 may comprise a light emitting diode (LED) display having clusters of red, green and blue diodes driven together to form full-color pixels. Each liquid crystal or pixel of the display 1222 changes to an opaque or translucent state to form a part of the image on the display in response to the data or information generated by the processor 1204 from the application of the instructions of the computer program 1210 and/or operating system 1208 to the input and commands. The image may be provided through a graphical user interface (GUI) module 1218. Although the GUI module 1218 is depicted as a separate module, the instructions performing the GUI functions can be resident or distributed in the operating system 1208, the computer program 1210, or implemented with special purpose memory and processors.

Some or all of the operations performed by the computer 1202 according to the computer program 1210 instructions may be implemented in a special purpose processor 1204B. In this embodiment, some or all of the computer program 1210 instructions may be implemented via firmware instructions stored in a read only memory (ROM), a programmable read only memory (PROM) or flash memory within the special purpose processor 1204B or in memory 1206. The special purpose processor 1204B may also be hardwired through circuit design to perform some or all of the operations to implement the present invention. Further, the special purpose processor 1204B may be a hybrid processor, which includes dedicated circuitry for performing a subset of functions, and other circuits for performing more general functions such as responding to computer program 1210 instructions. In one embodiment, the special purpose processor 1204B is an application specific integrated circuit (ASIC), graphics processing unit, processor configured for machine learning or artificial intelligence processing, or field programmable gate array.

The computer 1202 may also implement a compiler 1212 that allows an application or computer program 1210 written in a programming language such as C, C++, Assembly, SQL, PYTHON, PROLOG, MATLAB, RUBY, RAILS, HASKELL, or other language to be translated into processor 1204 readable code. Alternatively, the compiler 1212 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1210 accesses and manipulates data accepted from I/O devices and stored in the memory 1206 of the computer 1202 using the relationships and logic that were generated using the compiler 1212.

The computer 1202 also optionally comprises an external communication device such as a modem, satellite link, Ethernet card, or other device for accepting input from, and providing output to, other computers 1202.

In one embodiment, instructions implementing the operating system 1208, the computer program 1210, and the compiler 1212 are tangibly embodied in a non-transitory computer-readable medium, e.g., data storage device 1220, which could include one or more fixed or removable data storage devices, such as a zip drive, floppy disc drive 1224, hard drive, CD-ROM drive, tape drive, etc. Further, the operating system 1208 and the computer program 1210 are comprised of computer program 1210 instructions which, when accessed, read and executed by the computer 1202, cause the computer 1202 to perform the steps necessary to implement and/or use the present invention or to load the program of instructions into a memory 1206, thus creating a special purpose data structure causing the computer 1202 to operate as a specially programmed computer executing the method steps described herein. Computer program 1210 and/or operating instructions may also be tangibly embodied in memory 1206 and/or data communications devices 1230, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1202.

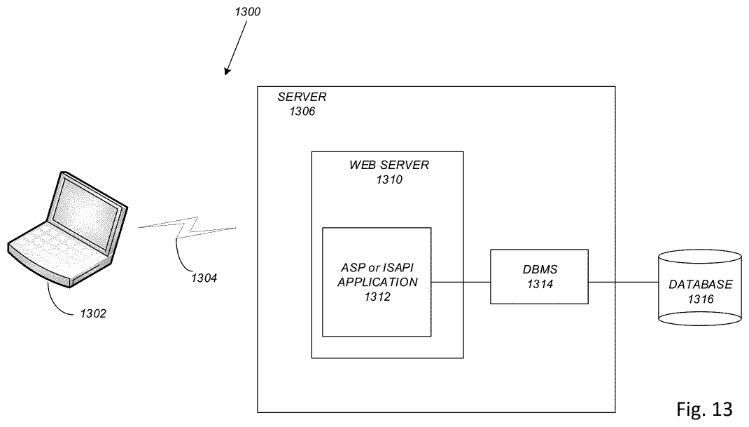

FIG. 13 schematically illustrates a typical distributed/cloud-based computer system 1300 using a network 1304 to connect client computers 1302 to server computers 1306. A typical combination of resources may include a network 1304 comprising the Internet, LANs (local area networks), WANs (wide area networks), SNA (systems network architecture) networks, or the like, clients 1302 that are personal computers or workstations (as set forth in FIG. 12), and servers 1306 that are personal computers, workstations, minicomputers, or mainframes (as set forth in FIG. 12). However, it may be noted that different networks such as a cellular network (e.g., GSM [global system for mobile communications] or otherwise), a satellite based network, or any other type of network may be used to connect clients 1302 and servers 1306 in accordance with embodiments of the invention.

A network 1304 such as the Internet connects clients 1302 to server computers 1306. Network 1304 may utilize ethernet, coaxial cable, wireless communications, radio frequency (RF), etc. to connect and provide the communication between clients 1302 and servers 1306. Further, in a cloud-based computing system, resources (e.g., storage, processors, applications, memory, infrastructure, etc.) in clients 1302 and server computers 1306 may be shared by clients 1302, server computers 1306, and users across one or more networks. Resources may be shared by multiple users and can be dynamically reallocated per demand. In this regard, cloud computing may be referred to as a model for enabling access to a shared pool of configurable computing resources.

Clients 1302 may execute a client application or web browser and communicate with server computers 1306 executing web servers 1310. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 1302 may be downloaded from server computer 1306 to client computers 1302 and installed as a plug-in or ACTIVEX control of a web browser. Accordingly, clients 1302 may utilize ACTIVEX components/component object model (COM) or distributed COM (DCOM) components to provide a user interface on a display of client 1302. The web server 1310 is typically a program such as MICROSOFT'S INTERNET INFORMATION SERVER.

Web server 1310 may host an Active Server Page (ASP) or Internet Server Application Programming Interface (ISAPI) application 1312, which may be executing scripts. The scripts invoke objects that execute business logic (referred to as business objects). The business objects then manipulate data in database 1316 through a database management system (DBMS) 1314. Alternatively, database 1316 may be part of, or connected directly to, client 1302 instead of communicating/obtaining the information from database 1316 across network 1304. When a developer encapsulates the business functionality into objects, the system may be referred to as a component object model (COM) system. Accordingly, the scripts executing on web server 1310 (and/or application 1312) invoke COM objects that implement the business logic. Further, server 1306 may utilize MICROSOFT'S TRANSACTION SERVER (MTS) to access required data stored in database 1316 via an interface such as ADO (Active Data Objects), OLE DB (Object Linking and Embedding DataBase), or ODBC (Open DataBase Connectivity).

Generally, these components 1300-1316 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1302 and 1306 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1302 and 1306. Embodiments of the invention are implemented as a software/CAD application on a client 1302 or server computer 1306. Further, as described above, the client 1302 or server computer 1306 may comprise a thin client device or a portable device that has a multi-touch-based display.

### Device and System Embodiments

Illustrative systems and methods according to embodiments of the present invention include, but are not limited to, the following examples (referring also to FIGS. 1-13).

1. A system for generating a pseudo random quantum state, comprising:
a quantum device 100 comprising a plurality of coherently interacting quantum systems 102 having a plurality of quantum degrees of freedom (e.g., position and/or atomic levels or states), wherein the quantum systems are prepared with a (e.g., high, that does not change based on system size, that is greater than 0.00001, and/or that is better than can be classical simulation) fidelity F in a well characterized (e.g., pure) quantum state |Ψ₀ [symbol] for the multiple quantum degrees of freedom;
a signal source (e.g., laser 152) for applying one or more signals 108,110 that quantum mechanically evolve the quantum state under the influence of couplings (e.g., intensity of a laser field driving transitions between quantum states to evolve the quantum state) and interactions (e.g.; van der Waals interactions) between the quantum systems and/or between the quantum systems and a source of decoherence; and
a detection system 150 for performing a measurement on a subset of the quantum systems resulting in a second quantum state of the unmeasured quantum systems, wherein the second quantum state is used as a source of pseudo random quantum states.

2. The device of example 1, wherein:
the quantum systems comprise neutral atoms 104; quantum dots, solid state defects, superconducting cubits or qudits, or trapped ions;
the subset comprises a first plurality B of the quantum systems; and
the unmeasured quantum systems comprise the remaining number A of the quantum systems.

3. The system of example 1, wherein:
the quantum device 100 comprises an array of neutral atoms 104 trapped in trapping potentials;
the quantum systems each comprise one of the atoms 104 comprising a first state |0 [symbol] and a second state |1 [symbol] ;
the signals comprise coherent electromagnetic radiation 110 configured to:
   initialize the systems in the first state, and
   quantum mechanically evolve the systems by applying the coherent electromagnetic radiation continuously driving a transition between the first state and second state, under the influence of the coherent electromagnetic radiation driving the transition and the interactions between the atoms;
the interactions comprise van der Waals interactions between the atoms; and
the degrees of freedom comprise the first state and the second state.

4. A computer implemented method to verify a quantum device, comprising:
obtaining a quantum device 102 comprising one or more quantum systems each having a quantum state for multiple quantum degrees of freedom; and
verifying at least one of a coupling strength between the quantum systems and/or between a source of decoherence and the quantum systems, or
a fidelity F of the quantum state; and
wherein the verifying comprises comparing measurement samples z of an evolved quantum state of the quantum systems, against expected behavior with time evolution obtained using a classical computer 170, 1200, to estimate at least one of the fidelity or the coupling strength.

5. The method of example 4, wherein the comparing is performed using an equation for the fidelity F.

6. The method of example 5, wherein the equation is:

$${F}_{c} = 2 \frac{{\sum }_{𝓏} p ( 𝓏 ) q ( 𝓏 )}{{\sum }_{𝓏} {p}^{2} ( 𝓏 )} - 1 or$$

$${F}_{d} = 2 \frac{{\sum }_{𝓏} p ( 𝓏 ) q ( 𝓏 ) / {p}_{d} ( 𝓏 )}{{\sum }_{𝓏} {p}^{2} ( 𝓏 ) / {p}_{d} ( 𝓏 )} - 1 or$$

$${F}_{e} = \frac{- 1 + {\sum }_{𝓏} p ( 𝓏 ) q ( 𝓏 ) / {p}_{d} ( 𝓏 )}{- 1 + {\sum }_{𝓏} {p}^{2} ( 𝓏 ) / {p}_{d} ( 𝓏 )}$$

where p(z) is the probability of the degree of freedom z from a calculation, q(z) is the probability from the measurement samples, and p_{d}(z) is the time-averaged probability from the calculation.

7. The method of example 5, wherein:
the equation for the fidelity is a function of one or more parameters characterizing the coupling strength that are measured in the measurement sample, and
the coupling strength is estimated using a variational method wherein the fidelity calculated from the equation is maximized by varying the one or more parameters in the equation.

8. The method of example 5, wherein the equation for the fidelity is a function of the measurement samples and the estimate is obtained by calculating the fidelity from the equation.

9. The method of example 4, wherein the time evolution obtained using the classical computer uses one or more classical approximate time evolution algorithms while utilizing an approximation method to estimate the fidelity of the quantum state via an extrapolation method.

10. The method of example 9, wherein the approximate time evolution algorithms comprise one or more tensor network based algorithms, one or more path integral sampling algorithms, and/or one or more machine learning based algorithms.

11. The method of example 9, wherein a performance of the approximate time evolution algorithm is systematically tuned in order to perform the extrapolation method.

12. The method of example 11, wherein the performance of the approximate time evolution algorithm comprising a tensor based network algorithm can be tuned by changing a bond dimension.

13. The method of example 11, wherein the systematic tuning is at least one of short delay time extrapolation or extrapolation via classical control.

14. The method of example 4, wherein the verifying characterizes the coupling strength by:
(a) preparing the quantum state of the quantum device, wherein the quantum state is well known (e.g., a pure quantum state) and/or preparing the quantum state with a fidelity that does not change based on system size, that is greater than 0.00001, and/or that is better than can be classical simulation);
(b) applying one or more signals to quantum mechanically evolve the well known quantum state under an influence of couplings (e.g., intensity of laser field driving transitions between atomic levels) and/or interactions (e.g., but not limited to, van der Wools interactions) between the quantum systems and/or between the quantum systems and a source of noise;
(c) performing a measurement on all quantum degrees of freedom (e.g., position and/or atomic levels) of the quantum systems resulting in a particular measurement sample of the quantum state;
(d) repeating steps (a)-(c) to obtain a plurality of the r Measurement samples (e.g., measurements); and
(e) comparing the measurement samples against the expected behavior with the time evolution obtained using the classical computer to obtain the estimate of the coupling strength.

15. The method of example 4, wherein the verifying characterizes the fidelity by:
(a) preparing the quantum state with unknown fidelity;
(b) applying one or more signals to quantum mechanically evolve the quantum state for a well known time duration under an influence of known couplings (e.g., intensity of laser field driving transition between atomic levels) and interactions (e.g., van der Waal s interactions), to form an evolved quantum state;
(c) performing measurement on all quantum degrees of freedom of the evolved quantum state resulting in a particular measurement sample of the evolved quantum state;
(d) repeating steps (a)-(c) to obtain a plurality of the measurement samples (e.g., measurements); and
(e) comparing the measurement samples against the expected behavior with time evolution obtained using the classical computer to obtain the estimate of the fidelity of the quantum state.

16. The method of example 4 wherein the verifying characterizes the fidelity and the coupling strength simultaneously by:
(a) preparing an initial quantum state of the quantum device, wherein the initial quantum state is initially imperfectly known with unknown fidelity;
(b) applying one or more signals to quantum mechanically evolve the quantum state for a known time duration and under an influence of couplings and interactions between the quantum systems and/or between the quantum systems and a source of noise, wherein the couplings are initially imperfectly unknown;
(c) performing a measurement on all quantum degrees of freedom of the quantum systems resulting in a particular measurement sample of the quantum state;
(d) repeating steps (a)-(c) to obtain a plurality of the measurement samples; and
(e) comparing the measurement samples against the expected behavior with the time evolution obtained using the classical computer to obtain the estimate of the coupling strength and/or the estimate of the fidelity, wherein:
the estimate of the fidelity in step (e) is used as an input to provide knowledge of the fidelity in a next iteration of step (a), and
the estimate of the coupling strength obtained in step (e) is an input to provide the knowledge of the coupling in step (b), so that performance of the method simultaneously estimates the fidelity of the initial quantum state and the coupling strength.

17. The method of example 4, wherein:
the quantum device comprises an array of neutral atoms trapped in trapping potentials and the quantum systems comprise a first state and a second state of each of the atoms, and
the interactions comprise interactions between the atoms, and
the couplings comprise coherent electromagnetic radiation driving a transition between the first state and the second state and the coupling strength is a function of the detuning of the coherent electromagnetic radiation from the transition.

18. A computer implemented system 1200 for verifying a quantum device 102, comprising:
a computer 170, 1200 coupled to or more quantum systems each having a quantum state for multiple quantum degrees of freedom, wherein:
the computer comprises one or more processors 1204; one or more memories 1206; and an application 1210 stored in the one or more memories, and
the application executed by the one or more processors verifies at least one of:
   a coupling strength between the quantum systems and/or between a source of decoherence and the quantum systems, or
   a fidelity of the quantum state of interest,
   by comparing measurement samples of an evolved quantum state of the quantum systems, against expected behavior with time evolution determined by the computer, to estimate at least one of the fidelity or the coupling strength.

19. The computer implemented system of example 18, wherein the application estimates the fidelity or the coupling strength by solving an equation for the fidelity:

20. The system of example 18, wherein the computer outputs an error detection signal if at least one of the fidelity or the coupling strength are outside an acceptable range of the expected behavior.

21. The system of example 18, wherein the quantum device comprises a quantum simulator or quantum computer.

22. A device or system for generating a pseudo random quantum state, comprising:
a quantum device (e.g. simulator or computer) comprising a plurality of coherently interacting quantum systems (e.g., qubits or qudits) having a plurality of quantum degrees of freedom (e.g., positions or atomic level), wherein the quantum systems are prepared in with high fidelity (e.g., does not change based on system size, or greater than 0.00001, or better than classical simulation) in a well characterized quantum state (e.g., pure quantum state) for the multiple quantum degrees of freedom;
a signal source (e.g., source for applying electromagnetic fields) for applying one or more signals (e.g., electromagnetic fields) to quantum mechanically evolve the quantum state under the influence of couplings and the interactions between the quantum systems (e.g., qubits/qudits) and/or between the quantum systems (e.g., qudits/qubits) and a source of decoherence; and
a detection system for performing a measurement (position or atomic level) on a subset of the qudits/qubits resulting in a second quantum state of the unmeasured qudits/qubits, wherein the second quantum state is used as a source of pseudo random quantum states.

23. The device of example 22, wherein the qubits or qudits comprise neutral atoms, quantum dots, solid state defects, superconducting qubits/qudits, or trapped ions, and the subset comprises a first plurality of the qudits/qubits, and the unmeasured qudits/qubits comprise the remaining number of the qudits/qubits.

24. The system of example 22 or 23, wherein:

the quantum device comprises an array of neutral atoms trapped in trapping potentials and the quantum systems each comprise one of the atoms comprising a first state and a second state comprising an excited Rydberg state,
the signals comprise electromagnetic radiation tuned to:
   initialize the systems in the first state, and
   quantum mechanically evolve the systems by applying a laser continuously driving a transition between the first state and second state, under the influence of the laser driving the transition and the interactions between the atoms, and
the detection system outputs readout signals triggering a measurement on the subset by exciting a transition from the Rydberg state,
the quantum device comprises optical tweezers forming the trapping potentials,
the interactions comprise van der Waals interactions between the atoms,
the degrees of freedom comprise atomic levels (which state it is in).

25. A method to verify a quantum device, comprising:
obtaining a quantum device comprising one or more quantum systems each having a quantum state of interest for multiple quantum degrees of freedom; and
verifying at least one of a coupling strength between the quantum systems and/or between a source of decoherence and the quantum systems, or
a fidelity of the quantum state of interest.

26. A method to characterize coupling strength among quantum systems (e.g., qubit/qudits) and/or between a source of decoherence and the quantum states (qudits or qubits), comprising:
(a) obtaining a quantum device comprising quantum systems (e.g., qudits or qubits) each having multiple quantum degrees of freedom;
(b) preparing a well characterized quantum state of the qubits or qudits with high fidelity, or wherein the quantum state is well known (e.g., not perfectly pure state with purity that does not depend on system size, or purity is larger 0.0001 but less than or equal to 1), or the quantum state is initially imperfectly known;
(c) applying one r more signals (e.g., electromagnetic field) to quantum mechanically evolve the well defined or imperfectly known quantum state under influence of the couplings and interactions;
(d) performing a measurement on all quantum degrees of freedom of the quantum systems (e.g., qudits or qubits) resulting in a particular measurement sample of the quantum state;
(e) repeating steps (b)-(d) to obtain a plurality of measurement samples; and
(f) comparing the measurement samples against expected behavior with time evolution obtained using classical computer to estimate the strength of the couplings.

27. A method to characterize fidelity, comprising:
(a) Obtaining a quantum device comprising multiple quantum degrees of freedom;
(b) preparing a quantum state of interest of the qubits or qudits, wherein the preparing of the quantum state of interest is with unknown fidelity;
(c) applying one or more signals (e.g., electromagnetic field) to quantum mechanically evolve the quantum state of interest in a predetermined, specific manner (e.g., for a well known time duration) and under influence of well characterized couplings and interactions;
(d) performing measurement on all quantum degrees of freedom of the evolved quantum state of interest resulting in a particular measurement sample of the evolved quantum state;
(e) repeating steps (b)-(d) to obtain a plurality of measurement samples;
(f) comparing the measurement samples against expected behavior with time evolution obtained using classical computer to estimate the fidelity of the quantum state of interest.

28. The method of example 26 and 27 performed simultaneously, wherein:
the initial state prepared in step (b) of example 24 is initially imperfectly known,
knowledge of the couplings in example 25 in step (c) is initially imperfect,
estimation of the fidelity obtained from example 25 step (f) is used as an input to provide knowledge of the fidelity in step (b) in example 24 and estimation of the coupling obtained in example 24 step (f) is used to provide the knowledge of the coupling in step (c) of example 25, so that performance of the methods of examples 24 and 25 simultaneously estimates the fidelity of the initial state in example 25 and the strength of the couplings used in example 24.

29. The method of examples 26 or 27, wherein the comparing in step (f) is performed by using an equation (e.g., an equation for fidelity, e.g. Fc, Fd, or Fe).

30. The method of examples 26 or 27 wherein the time evolution obtained using the computer is replaced by classical approximate time evolution algorithms and while utilizing an approximation method to estimate the fidelity of the quantum state of interest via an extrapolation method.

31. The method of examples 26 or 27 or 30, wherein the approximate tune evolution algorithms comprises tensor network based algorithms or path integral sampling algorithms and machine learning based algorithms.

32. The method of examples 30 or 31 wherein the performance of the approximate time evolution algorithm is systematically tuned in order to perform the extrapolation, e.g., the performance of tensor based network algorithms can be tuned by changing the bond dimension.

33. The method of example 32, wherein the systematic tuning is short delay time extrapolation, extrapolation via classical control.

34. The method or system of any of the examples 1-33 wherein “couplings” refers to single-particle control by an external control field, and “interactions” refers to multi-particle control mediated by their mutual interaction.

### REFERENCES

The following references are incorporated by reference herein.

### References for First and Second Examples

[1] Brandão, F. G. S. L., Chemissany, W., Hunter-Jones, N., Kueng, R. and Preskill, J. Models of Quantum Complexity Growth. PRX Quantum 2, 30316 (2021).
[2] Hayden, P. and Preskill, J. Black holes as mirrors: quantum information in random subsystems. Journal of High Energy Physics 2007, 120 (2007).
[3] Neill, C. et al. A blueprint for demonstrating quantum supremacy with superconducting qubits. Science 360, 195-199 (2018).
[4] Cross, A. W., Bishop, L. S., Sheldon, S., Nation, P. D. and Gambetta, J. M. Validating quantum computers using randomized model circuits. Physical Review A 100, 32328 (2019).
[5] Arute, F. et al. Quantum supremacy using a programmable superconducting processor. Nature 574, 505510 (2019).
[6] Wu, Y. et al. Strong Quantum Computational Advantage Using a Superconducting Quantum Processor. Physical Review Letters 127, 180501 (2021).
[7] Emerson, J., Weinstein, Y. S., Saraceno, M., Lloyd, S. and Cory, D. G. Pseudo-Random Unitary Operators for Quantum Information Processing. Science 302, 20982100(2003).
[8] Harrow, A. W. and Low, R. A. Random Quantum Circuits are Approximate 2-designs. Communications in Mathematical Physics 291, 257-302 (2009).
[9] Dankert, C., Cleve, R., Emerson, J. and Livine, E. Exact and approximate unitary 2-designs and their application to fidelity estimation. Physical Review A 80, 12304 (2009).
[10] Brandáo, F. G. S. L., Harrow, A. W. and Horodecki, M. Local Random Quantum Circuits are Approximate Polynomial-Designs. Communications in Mathematical Physics 346, 397-434 (2016).
[11] Ohliger, M., Nesme, V. and Eisert, J. Efficient and feasible state tomography of quantum many-body systems. New Journal of Physics 15, 15024 (2013).
[12] Onorati, E. et al. Mixing Properties of Stochastic Quantum Hamiltonians. Communications in Mathematical Physics 355, 905-947 (2017).
[13] Nakata, Y., Hirche, C., Koashi, M. and Winter, A. Efficient Quantum Pseudorandomness with Nearly TimeIndependent Hamiltonian Dynamics. Physical Review X 7, 21006 (2017).
[14] Elben, A., Vermersch, B., Dalmonte, M., Cirac, J. I. and Zoller, P. Renyi Entropies from Random Quenches in performing quantum fidelity estimation in a wide variety of quantum hardware, including trapped ions⁵⁴, superconducting qubits³, photonic systems⁵⁵, solid-state spins^{56,57}, and cold atoms and molecules in optical lattices⁵⁸. Ultimately, emergent random ensembles could find a broader range of applications, including quantum advantage tests^{5,6,18-20,55}, in situ Hamiltonian learning^{5,59} with potential quantum advantage⁴⁶, and Hamiltonian optimization.
Note added—during the course of the revision, a new fidelity estimator has been introduced⁶⁰; we present a comparison in Ref.⁴⁶.
Atomic Hubbard and Spin Models. Physical Review Letters 120, 50406 (2018).
[15] Kaufman, A. M. et al. Quantum thermalization through entanglement in an isolated many-body system. Science 353, 794-800 (2016).
[16] Popescu, S., Short, A. J. and Winter, A. Entanglement and the foundations of statistical mechanics. Nature Physics 2, 754-758 (2006).
[17] Cotler, J. et al. Emergent quantum state designs from individual many-body wavefunctions. arXiv:2103.03536 (2021).
[18] Boixo, S. et al. Characterizing quantum supremacy in near-term devices. Nature Physics 14, 595-600 (2018).
[19] Bouland, A., Fefferman, B., Nirkhe, C. and Vazirani, U. On the complexity and verification of quantum random circuit sampling. Nature Physics 15, 159-163 (2019).
[20] Haferkamp, J. et al. Closing Gaps of a Quantum Advantage with Short-Time Hamiltonian Dynamics. Physical Review Letters 125, 250501 (2020).
[21] Brydges, T. et al. Probing Renyi entanglement entropy via randomized measurements. Science 364, 260-263 (2019).
[22] Elben, A. et al. Cross-Platform Verification of Intermediate Scale Quantum Devices. Physical Review Letters 124, 10504(2020).
[23] Huang, H. Y., Kueng, R. and Preskill, J. Predicting many properties of a quantum system from very few measurements. Nature Physics 16, 1050-1057 (2020).
[24] Harrow, A. W. The Church of the Symmetric Subspace. arXiv:1308.6595 (2013).
[25] Li, K. M., Dong, H., Song, C. and Wang, H. Approaching the chaotic regime with a fully connected superconducting quantum processor. Physical Review A 100, 62302 (2019).
[26] Jurcevic, P. et al. Demonstration of quantum volume 64 on a superconducting quantum computing system. Quantum Science and Technology 6, 025020 (2021).
[27] Piroli, L., Sunderhauf, C. and Qi, X. L. A random unitary circuit model for black hole evaporation. Journal of High Energy Physics 2020, 63 (2020).
[28] Verstraete, F., Popp, M. and Cirac, J. I. Entanglement versus Correlations in Spin Systems. Physical Review Letters 92, 27901 (2004).
[29] Popp, M., Verstraete, F., Martin-Delgado, M. A. and Cirac, J. I. Localizable entanglement. Physical Review A 71, 42306 (2005). [30] Goldstein, S., Lebowitz, J. L., Tumulka, R. and Zanghi, N. On the Distribution of the Wave Function for Systems in Thermal Equilibrium. Journal of Statistical Physics 125, 1193-1221 (2006).
[31] Goldstein, S., Lebowitz, J. L., Mastrodonato, C., Tumulka, R. and Zanghi, N. Universal Probability Distribution for the Wave Function of a Quantum System Entangled with its Environment. Communications in Mathematical Physics 342, 965-988 (2016).
[32] Bernien, H. et al. Probing many-body dynamics on a 51 atom quantum simulator. Nature 551, 579-584 (2017).
[33] Browaeys, A. and Lahaye, T. Many-body physics with individually controlled Rydberg atoms. Nature Physics 16, 132-142 (2020).
[34] Madjarov, I. S. et al. High-fidelity entanglement and detection of alkaline-earth Rydberg atoms. Nature Physics 16, 857-861 (2020).
[35] Norcia, M. A., Young, A. W. and Kaufman, A. M. Microscopic Control and Detection of Ultracold Strontium in Optical-Tweezer Arrays. Physical Review X 8, 41054 (2018).
[36] Cooper, A. et al. Alkaline-Earth Atoms in Optical Tweezers. Physical Review X 8, 41055 (2018).
[37] Saskin, S., Wilson, J. T., Grinkemeyer, B. and Thompson, J. D. Narrow-Line Cooling and Imaging of Ytterbium Atoms in an Optical Tweezer Array. Physical Review Letters 122, 143002 (2019).
[38] Covey, J. P., Madjarov, I. S., Cooper, A. and Endres, M. 2000-Times Repeated Imaging of Strontium Atoms in Clock-Magic Tweezer Arrays. Physical Review Letters 122, 173201 (2019).
[39] Deutsch, J. M. Quantum statistical mechanics in a closed system. Physical Review A 43, 2046-2049 (1991).
[40] Srednicki, M. Chaos and quantum thermalization. Physical Review E 50, 888-901 (1994).
[41] Rigol, M., Dunjko, V. and Olshanii, M. Thermalization and its mechanism for generic isolated quantum systems. Nature 452, 854-858 (2008).
[42] Nandkishore, R. and Huse, D. A. Many-Body Localization and Thermalization in Quantum Statistical Mechanics. Annual Review of Condensed Matter Physics 6, 15-38 (2015).
[43] Abanin, D. A., Altman, E., Bloch, I. and Serbyn, M. Colloquium: Many-body localization, thermalization, and entanglement. Reviews of Modern Physics 91, 21001 (2019).
[44] Ueda, M. Quantum equilibration, thermalization and prethermalization in ultracold atoms. Nature Reviews Physics 2, 669-681 (2020).
[45] del Rio, L., Hutter, A., Renner, R. and Wehner, S. Relative thermalization. Physical Review E 94, 22104 (2016).
[46] Supplemental Material. See Supplemental Material for details of the experiment and theoretical models.
[47] Porter, C. E. and Thomas, R. G. Fluctuations of Nuclear Reaction Widths. Physical Review 104, 483-491 (1956).
[48] Ambainis, A. and Emerson, J. Quantum t-designs: t-wise Independence in the Quantum World. pages 129-140. IEEE (2007). ISBN 0-7695-2780-9.
[49] Khemani, V., Vishwanath, A. and Huse, D. A. Operator Spreading and the Emergence of Dissipative Hydrodynamics under Unitary Evolution with Conservation Laws. Physical Review X 8, 31057 (2018).
[50] Slagle, K. et al. Microscopic characterization of Ising conformal field theory in Rydberg chains. Physical Review B 104, 235109 (2021). [51] Fendley, P., Sengupta, K. and Sachdev, S. Competing density-wave orders in a one-dimensional hard-boson model. Physical Review B 69, 75106 (2004).
[52] Cotler, J., Hunter-Jones, N. and Ranard, D. Fluctuations of subsystem entropies at late times. Phys. Rev. A 105, 022416 (2022).
[53] Turner, C. J., Michailidis, A. A., Abanin, D. A., Serbyn, M. and Papie, Z. Weak ergodicity breaking from quantum many-body scars. Nature Physics 14, 745-749 (2018).
[54] Monroe, C. et al. Programmable Quantum Simulations of Spin Systems with Trapped Ions. arXiv:1912.07845 (2019).
[55] Zhong, H. S. et al. Quantum computational advantage using photons. Science 370, 1460-1463 (2020).
[56] Zwanenburg, F. A. et al. Silicon quantum electronics. Reviews of Modern Physics 85, 961-1019 (2013).
[57] Awschalom, D. D., Hanson, R., Wrachtrup, J. and Zhou, B. B. Quantum technologies with optically interfaced solid-state spins. Nature Photonics 12, 516-527 (2018).
[58] Gross, C. and Bloch, I. Quantum simulations with ultracold atoms in optical lattices. Science 357, 995-1001 (2017).
[59] Giovannetti, V. Quantum-Enhanced Measurements: Beating the Standard Quantum Limit. Science 306, 13301336 (2004).
[60] Mark, D. K., Choi, J., Shaw, A., Endres, M. and Choi, S. Benchmarking Quantum Simulators using Quantum Chaos. To be posted.
[61] Madjarov, I. S. et al. An Atomic-Array Optical Clock with Single-Atom Readout. Physical Review X 9, 41052 (2019).
[62] Barredo, D., de Leseleuc, S., Lienhard, V., Lahaye, T. and Browaeys, A. An atom-by-atom assembler of defect-free arbitrary two-dimensional atomic arrays. Science 354, 1021-1023 (2016).
[63] Endres, M. et al. Atom-by-atom assembly of defect-free one-dimensional cold atom arrays. Science 354, 10241027 (2016).
[64] de Léséleuc, S. et al. Observation of a symmetryprotected topological phase of interacting bosons with Rydberg atoms. Science 365, 775-780 (2019).
[65] Choi et. al., “Emergent Quantum Randomness and Benchmarking from Hamiltonian Many-body Dynamics” https://doi.org/10.48550/arXiv.2103.0353, Nature 613, 468 (2023)

### References for Third and Fourth Examples

[1] M. Greiner, O. Mandel, T. Esslinger, T. W. Hänsch, and I. Bloch, Quantum phase transition from a superfluid to a Mott insulator in a gas of ultracold atoms, Nature (London) 415, 39 (2002).
[2] M. Aidelsburger, M. Atala, M. Lohse, J. T. Barreiro, B. Paredes, and I. Bloch, Realization of the Hofstadter Hamiltonian with ultracold atoms in optical lattices, Phys. Rev. Lett. 111, 185301 (2013).
[3] G. Jotzu, M. Messer, R. Desbuquois, M. Lebrat, T. Uehlinger, D. Greif, and T. Esslinger, Experimental realization of the topological Haldane model with ultracold fermions, Nature (London) 515, 237 (2014).
[4] C. Gross and I. Bloch, Quantum simulations with ultracold atoms in optical lattices, Science 357, 995 (2017).
[5] S. Ebadi, T. T. Wang, H. Levine, A. Keesling, G. Semeghini, A. Omran, D. Bluvstein, R. Samajdar, H. Pichler, W. W. Ho, et al., Quantum phases of matter on a 256-atom programmable quantum simulator, Nature (London) 595, 227 (2021).
[6] A. M. Kaufman, M. E. Tai, A. Lukin, M. Rispoli, R. Schittko, P. M. Preiss, and M. Greiner, Quantum thermalization through entanglement in an isolated manybody system, Science 353, 794 (2016).
[7] Y. Tang, W. Kao, K.-Y. Li, S. Seo, K. Mallayya, M. Rigol, S. Gopalakrishnan, and B. L. Lev, Thermalization near integrability in a dipolar quantum Newton's cradle, Phys. Rev. X 8, 021030 (2018).
[8] F. Chen, Z.-H. Sun, M. Gong, Q. Zhu, Y.-R. Zhang, Y. Wu, Y. Ye, C. Zha, S. Li, S. Guo, et al., Observation of strong and weak thermalization in a superconducting quantum processor, Phys. Rev. Lett. 127, 020602 (2021).
[9] B. Neyenhuis, J. Zhang, P. W. Hess, J. Smith, A. C. Lee, P. Richerme, Z.-X. Gong, A. V. Gorshkov, and C. Monroe, Observation of prethermalization in long-range interacting spin chains, Science Adv. 3, e1700672 (2017).
[10] J. Zhang, G. Pagano, P. W. Hess, A. Kyprianidis, P. Becker, H. Kaplan, A. V. Gorshkov, Z.-X. Gong, and C. Monroe, Observation of a many-body dynamical phase transition with a 53-qubit quantum simulator, Nature (London) 551, 601 (2017).
[11] J. Choi, H. Zhou, S. Choi, R. Landig, W. W. Ho, J. Isoya, F. Jelezko, S. Onoda, H. Sumiya, D. A. Abanin, et al., Probing quantum thermalization of a disordered dipolar spin ensemble with discrete time-crystalline order, Phys. Rev. Lett. 122, 043603 (2019).
[12] A. Rubio-Abadal, M. Ippoliti, S. Hollerith, D. Wei, J. Rui, S. Sondhi, V. Khemani, C. Gross, and I. Bloch, Floquet prethermalization in a Bose-Hubbard system, Phys. Rev. X 10, 021044 (2020).
[13] P. Peng, C. Yin, X. Huang, C. Ramanathan, and P. Cappellaro, Floquet prethermalization in dipolar spin chains, Nature Physics 17, 444 (2021).
[14] X. Mi, M. Ippoliti, C. Quintana, A. Greene, Z. Chen, J. Gross, F. Arute, K. Arya, J. Atalaya, R. Babbush, et al., Time-crystalline eigenstate order on a quantum processor, Nature (London), 1 (2021).
[15] J. Eisert, D. Hangleiter, N. Walk, I. Roth, D. Markham, R. Parekh, U. Chabaud, and E. Kashefi, Quantum certification and benchmarking, Nature Rev. Phys. 2, 382 (2020).
[16] M. A. Nielsen and I. L. Chuang, Quantum Computation and Quantum Information: 10th Anniversary Edition (Cambridge University Press, 2010).
[17] M. Cramer, M. B. Plenio, S. T. Flammia, R. Somma, D. Gross, S. D. Bartlett, O. Landon-Cardinal, D. Poulin, and Y.-K. Liu, Efficient quantum state tomography, Nature Comm. 1, 1 (2010).
[18] D. Gross, Y.-K. Liu, S. T. Flammia, S. Becker, and J. Eisert, Quantum state tomography via compressed sensing, Phys. Rev. Lett. 105, 150401 (2010).
[19] M. Christandl and R. Renner, Reliable quantum state tomography, Phys. Rev. Lett. 109, 120403 (2012).
[20] S. T. Flammia and Y.-K. Liu, Direct fidelity estimation from few Pauli measurements, Phys. Rev. Lett. 106, 230501 (2011).
[21] M. P. da Silva, O. Landon-Cardinal, and D. Poulin, Practical characterization of quantum devices without tomography, Phys. Rev. Lett. 107, 210404 (2011).
[22] S. Aaronson, Shadow tomography of quantum states, SIAM Journal on Computing 49, STOC18 (2019).
[23] H.-Y. Huang, R. Kueng, and J. Preskill, Predicting many properties of a quantum system from very few measurements, Nature Physics 16, 1050 (2020).
[24] A. Elben, B. Vermersch, C. F. Roos, and P. Zoller, Statistical correlations between locally randomized measurements: A toolbox for probing entanglement in manybody quantum states, Phys. Rev. A 99, 052323 (2019).
[25] A. Elben, B. Vermersch, R. van Bijnen, C. Kokail, T. Brydges, C. Maier, M. K. Joshi, R. Blatt, C. F. Roos, and P. Zoller, Cross-platform verification of intermediate scale quantum devices, Phys. Rev. Lett. 124, 010504 (2020).
[26] Y. Liu, M. Otten, R. Bassirianjahromi, L. Jiang, and B. Fefferman, Benchmarking near-term quantum computers via random circuit sampling, arXiv:2105.05232 (2021).
[27] A. Elben, S. T. Flammia, H.-Y. Huang, R. Kueng, J. Preskill, B. Vermersch, and P. Zoller, The randomized measurement toolbox, arXiv:2203.11374 (2022).
[28] M. Ohliger, V. Nesme, and J. Eisert, Efficient and feasible state tomography of quantum many-body systems, N. J. Phys. 15, 015024 (2013).
[29] T. Brydges, A. Elben, P. Jurcevic, B. Vermersch, C. Maier, B. P. Lanyon, P. Zoller, R. Blatt, and C. F. Roos, Probing Rényi entanglement entropy via randomized measurements, Science 364, 260 (2019).
[30] Z. Li, L. Zou, and T. H. Hsieh, Hamiltonian tomography via quantum quench, Phys. Rev. Lett. 124, 160502 (2020).
[31] C. Kokail, R. van Bijnen, A. Elben, B. Vermersch, and P. Zoller, Entanglement hamiltonian tomography in quantum simulation, Nature Physics 17, 936 (2021).
[32] M. Gluza and J. Eisert, Recovering quantum correlations in optical lattices from interaction quenches, Phys. Rev. Lett. 127, 090503 (2021).
[33] H.-Y. Hu, S. Choi, and Y.-Z. You, Classical shadow tomography with locally scrambled quantum dynamics, arXiv:2107.04817 (2021).
[34] J. Choi, A. L. Shaw, I. S. Madjarov, X. Xie, J. Covey, J. Cotler, D. K. Mark, H.-Y. Huang, A. Kale, H. Pichler, F. G. Brandao, S. Choi, and M. Endres, Emergent randomness and benchmarking from many-body quantum chaos, arXiv:2103.03535 (2021).
[35] See Supplemental material of [69] for the proof of our theorem, detailed analysis of the performance, numerical demonstration, and limitations of our protocol, which includes Refs. [44, 61-66].
[36] S. Boixo, S. V. Isakov, V. N. Smelyanskiy, R. Babbush, N. Ding, Z. Jiang, M. J. Bremner, J. M. Martinis, and H. Neven, Characterizing quantum supremacy in nearterm devices, Nature Physics 14, 595 (2018).
[37] A. Nahum, S. Vijay, and J. Haah, Operator spreading in random unitary circuits, Phys. Rev. X 8, 021014 (2018).
[38] V. Khemani, A. Vishwanath, and D. A. Huse, Operator spreading and the emergence of dissipative hydrodynamics under unitary evolution with conservation laws, Phys. Rev. X 8, 031057 (2018).
[39] This is equivalent to the bitstring probability distribution obtained from a diagonal ensemble

$${ρ}_{d} = {lim}_{τ \to ∞} \frac{1}{τ} {\int }_{0}^{τ} \vert Ψ ( t ) 〉 〈 Ψ ( t ) \vert dt .$$

[40] X. Gao, M. Kalinowski, C.-N. Chou, M. D. Lukin, B. Barak, and S. Choi, Limitations of linear cross-entropy as a measure for quantum advantage, arXiv:2112.01657 (2021).
[41] A. M. Dalzell, N. Hunter-Jones, and F. G. S. L. Brandao, Random quantum circuits transform local noise into global white noise, arXiv:2111.14907 (2021).
[42] K. Noh, L. Jiang, and B. Fefferman, Efficient classical simulation of noisy random quantum circuits in one dimension, Quantum 4, 318 (2020).
[43] B. Barak, C.-N. Chou, and X. Gao, Spoofing linear crossentropy benchmarking in shallow quantum circuits, arXiv preprint arXiv:2005.02421 (2020).
[44] J. S. Cotler, D. K. Mark, H.-Y. Huang, F. Hernandez, J. Choi, A. L. Shaw, M. Endres, and S. Choi, Emergent quantum state designs from individual many-body wavefunctions, arXiv:2103.03536 (2021).
[45] S. Goldstein, J. L. Lebowitz, R. Tumulka, and N. Zanghi, On the distribution of the wave function for systems in thermal equilibrium, J. Stat. Phys. 125, 1193 (2006).
[46] P. Reimann, Foundation of statistical mechanics under experimentally realistic conditions, Phys. Rev. Lett. 101, 190403 (2008).
[47] N. Linden, S. Popescu, A. J. Short, and A. Winter, Quantum mechanical evolution towards thermal equilibrium, Phys. Rev. E 79, 061103 (2009).
[48] K. Kaneko, E. Iyoda, and T. Sagawa, Characterizing complexity of many-body quantum dynamics by higherorder eigenstate thermalization, Phys. Rev. A 101, 042126(2020).
[49] Y. Huang, Extensive entropy from unitary evolution, arXiv:2104.02053 (2021).
[50] F. H. Essler, H. Frahm, F. Gohmann, A. Klumper, and V. E. Korepin, The one-dimensional Hubbard model (Cambridge University Press, 2005).
[51] J. M. Deutsch, Eigenstate thermalization hypothesis, Rep. Prog. Phys. 81, 082001 (2018).
[52] A. J. Daley, Quantum trajectories and open many-body quantum systems, Adv. Phys. 63, 77 (2014).
[53] X. Mi, P. Roushan, C. Quintana, S. Mandra, J. Marshall, C. Neill, F. Arute, K. Arya, J. Atalaya, R. Babbush, et al., Information scrambling in quantum circuits, Science 374, 1479 (2021).
[54] R. Nandkishore and D. A. Huse, Many-body localization and thermalization in quantum statistical mechanics, Annu. Rev. Condens. Matter Phys. 6, 15 (2015).
[55] D. A. Abanin, E. Altman, I. Bloch, and M. Serbyn, Colloquium: Many-body localization, thermalization, and entanglement, Rev. Mod. Phys. 91, 021001 (2019).
[56] J. Haferkamp, C. Bertoni, I. Roth, and J. Eisert, Emergent statistical mechanics from properties of disordered random matrix product states, PRX Quantum 2, 040308 (2021).
[57] X. Liu, C. Guo, Y. Liu, Y. Yang, J. Song, J. Gao, Z. Wang, W. Wu, D. Peng, P. Zhao, F. Li, H.-L. Huang, H. Fu, and D. Chen, Redefining the quantum supremacy baseline with a new generation sunway supercomputer, arXiv:2111.01066 (2021).
[58] S. Paeckel, T. Köhler, A. Swoboda, S. R. Manmana, U. Schollwock, and C. Hubig, Time-evolution methods for matrix-product states, Ann. Phys. 411, 167998 (2019).
[59] J. Napp, R. L. La Placa, A. M. Dalzell, F. G. Brandao, and A. W. Harrow, Efficient classical simulation of random shallow 2D quantum circuits, Phys. Rev. X (2019).
[60] F. Arute, K. Arya, R. Babbush, D. Bacon, J. C. Bardin, R. Barends, R. Biswas, S. Boixo, F. G. Brandão, D. A. Buell, et al., Quantum supremacy using a programmable superconducting processor, Nature (London) 574, 505 (2019). [61] A. J. Short, Equilibration of quantum systems and subsystems, N. J. Phys. 13, 053009 (2011).
[62] S. Sarkar, S. Langer, J. Schachenmayer, and A. J. Daley, Light scattering and dissipative dynamics of many fermionic atoms in an optical lattice, Phys. Rev. A 90, 023618 (2014).
[63] C. J. Turner, A. A. Michailidis, D. A. Abanin, M. Serbyn, and Z. Papić, Quantum scarred eigenstates in a rydberg atom chain: Entanglement, breakdown of thermalization, and stability to perturbations, Phys. Rev. B 98 (2018).
[64] C. E. Porter and R. G. Thomas, Fluctuations of nuclear reaction widths, Phys. Rev. 104, 483 (1956).
[65] H. Bernien, S. Schwartz, A. Keesling, H. Levine, A. Omran, H. Pichler, S. Choi, A. S. Zibrov, M. Endres, M. Greiner, et al., Probing many-body dynamics on a 51-atom quantum simulator, Nature (London) 551, 579 (2017).
[66] R. Vasseur and J. E. Moore, Nonequilibrium quantum dynamics and transport: from integrability to manybody localization, J. Stat. Mech. 2016, 064010 (2016).
[69] Benchmarking Quantum Simulators using Quantum Chaos Daniel K. Mark, Joonhee Choi, Adam L. Shaw, Manuel Endres, Soonwon Choi https://arxiv.org/abs/2205.12211

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A system for generating a pseudo random quantum state, comprising:
a quantum device comprising a plurality of coherently interacting quantum systems having a plurality of quantum degrees of freedom, wherein the quantum systems are prepared with a fidelity in a well characterized quantum state for the multiple quantum degrees of freedom;
a signal source for applying one or more signals that quantum mechanically evolve the quantum state under the influence of couplings and interactions between the quantum systems and/or between the quantum systems and a source of decoherence; and
a detection system for performing a measurement on a subset of the quantum systems resulting in a second quantum state of the unmeasured quantum systems, wherein the second quantum state is used as a source of pseudo random quantum states.

2. The device of claim 1, wherein:
the quantum systems comprise neutral atoms, quantum dots, solid state defects, superconducting qubits or audits, or trapped ions;
the subset comprises a first plurality of the quantum systems; and
the unmeasured quantum systems comprise the remaining number of the quantum systems.

3. The system of claim 1, wherein:
the quantum device comprises an array of neutral atoms trapped in trapping potentials;
the quantum systems each comprise one of the atoms comprising a first state and a second state;
the signals comprise coherent electromagnetic radiation configured to:
initialize the systems in the first state, and
quantum mechanically evolve the systems by applying the coherent electromagnetic radiation continuously driving a transition between the first state and second state; under the influence of the coherent electromagnetic radiation driving the transition and the interactions between the atoms;
the interactions comprise van der Waals interactions between the atoms; and
the degrees of freedom comprise the first state and the second state.

4. A computer implemented method to verify a quantum device, comprising:
obtaining a quantum device comprising one or more quantum systems each having a quantum state for multiple quantum degrees of freedom; and
verifying at least one of a coupling strength between the quantum systems and/or between a source of decoherence and the quantum systems, or
a fidelity of the quantum state; and
wherein the verifying comprises comparing measurement samples of an evolved quantum state of the quantum systems, against expected behavior with time evolution obtained using a classical computer, to estimate at least one of the fidelity or the coupling strength.

5. The method of claim 4, wherein the comparing is performed using an equation for the fidelity.

6. The method of claim 5, wherein the equation is:
$${F}_{c} = 2 \frac{{\sum }_{𝓏} p ( 𝓏 ) q ( 𝓏 )}{{\sum }_{𝓏} {p}^{2} ( 𝓏 )} - 1 or$$
$${F}_{d} = 2 \frac{{\sum }_{𝓏} p ( 𝓏 ) q ( 𝓏 ) / {p}_{d} ( 𝓏 )}{{\sum }_{𝓏} {p}^{2} ( 𝓏 ) / {p}_{d} ( 𝓏 )} - 1 or$$
$${F}_{e} = \frac{- 1 + {\sum }_{𝓏} p ( 𝓏 ) q ( 𝓏 ) / {p}_{d} ( 𝓏 )}{- 1 + {\sum }_{𝓏} {p}^{2} ( 𝓏 ) / {p}_{d} ( 𝓏 )}$$
where p(z) is the probability of the degree of freedom z from a calculation, q(z) is the probability from the measurement, and p_{d}(z) is the time-averaged probability from the calculation.

8. The method of claim 5, wherein:
the equation for the fidelity is a function of one or more parameters characterizing the coupling strength that are measured in the measurement sample, and
the coupling strength is estimated using a variational method wherein the fidelity calculated from the equation is maximized by varying the one or more parameters in the equation.

8. The method of claim 5, wherein the equation for the fidelity is a function of the measurement samples and the estimate is obtained by calculating the fidelity from the equation.

9. The method of claim 4, Wherein the time evolution obtained using the classical computer uses one or more classical approximate time evolution algorithms while utilizing an approximation method to estimate the fidelity of the quantum state via an extrapolation method.

10. The method of claim 9, wherein the approximate time evolution algorithms comprise one or more tensor network based algorithms, one or more path integral sampling algorithms, and/or one or more machine learning based algorithms.

11. The method of claim 9, Wherein a performance of the approximate time evolution algorithm is systematically tuned in order to perform the extrapolation method.

12. The method of claim 11, wherein the performance of the approximate time evolution algorithm comprising a tensor based network algorithm can be tuned by changing a bond dimension.

13. The method of claim 11, wherein the systematic tuning is at least one of short delay time extrapolation or extrapolation via classical control.

14. The method of claim 4, wherein the verifying characterizes the coupling strength by:
(a) preparing the quantum state of the quantum device, wherein the quantum state is well known;
(b) applying one or more signals to quantum mechanically evolve the well known quantum state under an influence of couplings and interactions between the quantum systems and/or between the quantum systems and a source of noise;
(c) performing a measurement on all quantum degrees of freedom of the quantum systems resulting in a particular measurement sample of the quantum state;
(d) repeating steps (a)-(c) to obtain a plurality of the measurement samples; and
(e) comparing the measurement samples against the expected behavior with the time evolution obtained using the classical computer to obtain the estimate of the coupling strength.

15. The method of claim 4, wherein the verifying characterizes the fidelity by:
(a) preparing the quantum state with unknown fidelity;
(b) applying one or more signals to quantum mechanically evolve the quantum state for a well known time duration under an influence of known couplings and interactions, to form an evolved quantum state;
(c) performing measurement on all quantum degrees of freedom of the evolved quantum state resulting in a particular measurement sample of the evolved quantum state;
(d) repeating steps (a)-(c) to obtain a plurality of the measurement samples; and
(e) comparing the measurement samples against the expected behavior with time evolution obtained using the classical computer to obtain the estimate of the fidelity, of the quantum state.

16. The method of claim 4 wherein the verifying characterizes the fidelity and the coupling strength simultaneously by:
(a) preparing an initial quantum state of the quantum device, wherein the initial quantum state is initially imperfectly known with unknown fidelity;
(b) applying one or more signals to quantum mechanically evolve the quantum state for a known time duration and under an influence of couplings and interactions between the quantum systems and/or between the quantum systems and a source of noise, wherein the couplings are initially imperfectly unknown;
(c) performing a measurement on all quantum degrees of freedom of the quantum systems resulting in a particular measurement sample of the quantum state;
(d) repeating steps (a)-(c) to obtain a plurality of the measurement samples; and
(e) comparing the measurement samples against the expected behavior with the time evolution obtained using the classical computer to obtain the estimate of the coupling strength and/or the estimate of the fidelity, wherein:
the estimate of the fidelity in step (e) is used as an input to provide knowledge of the fidelity in a next iteration of step (a), and
the estimate of the coupling strength obtained in step (e) is an input to provide the knowledge of the coupling in step (b), so that performance of the method simultaneously estimates the fidelity of the initial quantum state and the coupling strength.

17. The method of claim 4, wherein:
the quantum device comprises an array of neutral atoms trapped in trapping potentials and the quantum systems comprise a first state and a second state of each of the atoms, and
the interactions comprise interactions between the atoms, and
the couplings comprise coherent electromagnetic radiation driving a transition between the first state and the second state and the coupling strength is a function of the detuning of the coherent electromagnetic radiation from the transition.

18. A computer implemented system for verifying a quantum device, comprising:
a computer coupled to or more quantum systems each having a quantum state for multiple quantum degrees of freedom, wherein:
the computer comprises one or more processors; one or more memories; and an application stored in the one or more memories, and
the application executed by the one or more processors verifies at least one of:
a coupling strength between the quantum systems and/or between a source of decoherence and the quantum systems, or
a fidelity of the quantum state of interest,
by comparing measurement samples of an evolved quantum state of the quantum systems, against expected behavior with time evolution determined by the computer, to estimate at least one of the fidelity or the coupling strength.

19. The computer implemented system of claim 18, wherein the application estimates the fidelity or the coupling strength by solving an equation for the fidelity.

20. The system of claim 18, wherein the quantum device comprises a quantum simulator or quantum computer.
